(19) United States
(12) Patent Application Publication
(10) Pub. No.: US 2004/0158632 A1
(43) Pub. Date: Aug. 12, 2004

(54) Recovery of interrupted communication for remote management of devices

(76) Inventor: Katuhiko Sasaki, Yokohama-shi (JP)

Correspondence Address: KNOBLE & YOSHIDA, LLC, Suite 1350, Eight Penn Center, 1628 John F. Kennedy Blvd., Philadelphia, PA, 19103, US

(21) Appl. No.: 10/754,234

(22) Filed: Jan. 9, 2004

(30) Foreign Application Priority Data
Jan. 10, 2003 (JP) 2003-005129

(51) Int. Cl. G06F 15/16

(52) U.S. Cl. 709/224; 709/237

(57) ABSTRACT

The devices including image forming devices are remotely managed by a management apparatus through communication. The communication is often interrupted during the remote management of the devices. One exemplary cause for the interrupted communication is an intentional temporary power supply deactivation of the managed devices by the user in the attempt to reset the devices in trouble or malfunction. The interrupted communication is promptly and accurately recovered subsequent to the activation of the power supply based upon a predetermined monitoring device such as a communication in-progress flag.

### FILED OF INVENTION

The current invention is generally related to a computer program and a communication device and more particularly related to a remote management system via network for communication devices, a method of controlling the communication devices and a computer program controlling the above system:

### BACKGROUND OF INVENTION

A remote management system was proposed in the past that a remote management device at a service center remotely controls managed devices via networks such as the Internet and public lines. The managed devices includes electronic devices with measuring units and communication units. The measuring units are applicable to the water, electricity and gas consumption, air conditioning units, electrical power supply units, medical devices, automatic vending machines, the network-based consumer electronics as well as the image processing devices. Certain image processing devices includes multi-functional digital devices, scanners, digital copies, facsimiles (fax) and printers with communication capability.

On the other hand, if the managed devices do not have communication capability, it has been proposed that an intermediate device with the communication function is connected via network and that a remote management system manages the managed devices via the network and the intermediate device. For example, if the managed device is an image processing device, it is common to use the know photo electro static process for forming an image on regular paper. The photo electro static process has a relatively high incident rate for malfunction. Furthermore, since it is necessary to regularly overhaul for maintaining the performance, service has been adapted for conservative management.

To achieve the conservative management, the remote management system for image forming devices includes a communication unit either inside or outside of the image forming devices. The image forming device is connected to the management device at the service center via public lines such as a telephone line. A product as disclosed in Japanese Patent Publication 2002-6693 is commercially available for communicating situational information with a management device via a communication unit. The situational information is detected by a situation detection sensor when certain conditions occur for reporting a pre-abnormal situation including a preventive alert for precautionary safety such as reaching a predetermined detected level of a certain sensor and an abnormal situation such as a malfunction after a self-diagnosis in the image forming device. The situational information to the management device includes a repair personnel call for reporting the self-diagnosed abnormal information and an alert call such as a supply call for reporting preventive information upon issuing a precautionary alert.

FIGS. 33 through 37 describe the details of controlling the precautionary situations or responding to the preventive alert signals in the image forming devices in the remote management system. Referring to FIGS. 33 and 34, sequential charts illustrate two examples of the communication sequence after the occurrence of the preventive alert in the image forming device in a conventional remote management system. The image forming device includes a sensor or a situation detection unit inside a plotter engine for monitoring the operation of the plotter engine. For example, when a preventive alert such as near toner end occurs after a toner supply amount reaches below a predetermined level in the toner bottle, the situation detection unit detects the toner near end and reports it to central processing unit (CPU) in the controller.

The CPU in the controller determines the occurrence of toner near end in a sequence S33-1 or S34-1 in the plotter engine upon receiving the toner near end information from the plotter engine. The CPU checks in non-volatile Random Access Memory (NV-RAM) a toner supply call complete flag (a call complete flag) in a sequence S33-2 or S34-2 and a post toner supply call paper sheet counter (a post call through paper counter) in a sequence S33-3 or S34-3. If the call complete flag is reset to “0” and the call complete paper counter is more than 1000, the CPU determines that the toner supply call condition has been satisfied after its issuance. However, if the device has not yet called a toner supply call once, the above condition is ignored.

After a toner supply call retrial counter (a retrial counter) in the NV-RAM is set to “3 in a sequence S33-4 or S34-4,” a message for a toner supply call is reported to a line adaptor or an intermediate device in a sequence S33-5 or S34-5. As described above, the toner supply call is an automatic report of the toner supply call information to order a toner bottle after toner near end occurs. A display device on the operation unit displays the message, “toner supply call.” The line adaptor receives the toner supply call message from the controller and sends the toner supply call via public line to the management device at a service center in a sequence S33-6 or S34-6. In others words, the toner supply call information or preventive information for ordering a toner bottle is automatically reported to the management device at the service center via public line.

The management device at the service center receives the toner supply call information from the line adaptor at the user device side such as an image forming device. Upon completion of the normal reception, the management device transmits the normal call result OK signal indicative of a successful handling of the toner supply call to the transmission source of the line adaptor via public line in a sequence S33-7. Then, the received toner supply information is stored in a queue such as a database in a hard disk and is processed by an operator of the management device. In other words, the call is held in the queue until a toner bottle is ordered, and the received toner supply call information is displayed to the operator. A center operator confirms the toner bottle order based upon the display message on the display unit in the management device after toner near end occurs in the image forming engine at the transmission source to which the line adaptor is connected. The center operator then performs the toner bottle ordering task by, for example, arranging a delivery of the toner bottle by a service man to the location at the transmission source adaptor. The transmission line adaptor receives a call OK from the management device as a result of the toner supply call to the management device at the service center. The result is a transmission result after transmitting the toner supply call information while the call OK is a transmission result indicative of normal reception of the toner supply call information.

The CPU of the controller in the image forming device receives the call OK from the line adaptor and determines the successful toner supply call to the management device in a sequence S33-8. The toner supply call success message is displayed on the character display unit on the operator unit. Furthermore, the toner supply call complete flag in the NV-RAM 202 is reset to 1 to indicate the successful toner supply call completion. After the NV-RAM call, the through paper counter is reset to 0 for counting from 0.

After the toner bottle in the plotter engine is replaced in the image forming device, toner full is issued as the toner amount is full in the toner bottle. The situation detecting unit detects the toner full condition and reports it to the controller. The CPU in the controller receives the toner full report from the plotter engine and resets the call completion flag to “0” in the NV-RAM to be ready for a next near end supply call in a sequence S33-9. However, if the post call paper counter value is not “1000,” a supply call is not made. Subsequently, the post call paper counter and the retrial counter are reset respectively in a sequence S33-10 and S33-11. After toner is replaced, the plotter engine sends a toner full signal to the CPU in a sequence S33-12, and the CPU resets the call complete flag in the NV-RAM in a sequence S33-13.

On the other hand, if the transmission source line adaptor does not receive the call OK indicative of the result of the normal completion for the reception of the toner supply call information from the management device after a predetermined amount of time has passed subsequent to transmitting the toner supply call to the management device at the service center, the transmission source line adaptor reports a call NG signal to the controller of the image forming device as shown in a sequence S34-7 of FIG. 34. The controller CPU in the image forming device receives the call NG signal, determines the failure of the toner supply call to the management device and displays the “toner supply call failure” message on the display unit on the operation device in a sequence S34-8. Furthermore, the retrial counter in the NV-RAM is decremented by one in a sequence S34-9. If the retrial counter value is not “0” from the predetermined initial retrial value of three for the same toner supply call, the same initial toner supply call message is again reported to the line adaptor as in a sequence S34-10. The initial report means the initial toner supply call in the same toner supply call information. The line adaptor receives from the controller the message for the toner supply call that is the same as that of the initial report and causes the management device at the service center to perform the toner supply call again via public line in a sequence S34-11. That is, the identical toner supply call information at the initial report is automatically again reported to the management device at the service center via public line.

Subsequently, if a call OK is not received from a corresponding management device after a predetermined amount of time as the result of the toner supply call to the management device at the service center, a call NG is again sent to the controller of their image forming device: The controller CPU in the image forming device again receives a call NG from the line adaptor in sequences S34-12 and S34-13, determines the failure of the toner supply call to the management device and decrements the retrial counter value by one in the NV-RAM in a sequence S34-14: The CPU further checks the retrial counter value. If the retrial counter value is not “0,” the toner supply call message at the initial time is again reported to the line adaptor for the third time in a sequence S34-15 and the above described operations are repeated. The CPU again subsequently receives the call NG from the line adaptor, determines the failed toner supply call to the management device in sequences as S34-17 and S34-18 and decrements the retrial counter value by one in the NV-RAM in a sequence S34-19. The CPU checks the retrial counter value and if it is “0” indicative of reaching the predetermined maximal retrial number for the same toner supply call information, the report to the line adaptor is terminated for the initial toner supply call message.

Now referring to FIG. 35, a flow chart illustrates exemplary steps involved in the toner near end handling process by the controller CPU in the image forming device according to the conventional technology. Upon detecting the toner near end in the plotter engine by the situation detection unit, the controller CPU in the image forming device receives the toner near end report and initiates the process of FIG. 35. First, in a step S101, the status is checked in the toner supply call completion flag in NV-RAM. If it is confirmed that the toner supply call completion flag has been reset to “0” to indicate an initial toner supply call the process proceeds to a step S102. After the image forming device is delivered, it is determined whether a first supply call is made. If toner near end occurs and the first supply call is ever made after the delivery, the process proceeds to the step S104. On the other hand, if no first supply call is made, in a step S103 it is determined whether the post call paper counter value in NV-RAM indicative of a number of paper sheets has reached “1000.” Upon reaching 1000 sheets, the process proceeds to the step S104. The above determination is made to counter a false detection of toner near end due to an open door condition.

In the step S104, the retrial counter in NV-RAM is set to “3.” In a step S105, the toner supply call message is reported to the line adaptor, and a toner supply call is performed by the management device at the service center via public line. Subsequently, if a call OK report is received from the line adaptor while waiting for a report from the line adaptor, it is determined that the toner supply call is successfully made to the management device in a step S106 and the process proceeds to a step S107 for performing the following steps. On the other hand, if a call NG is received from the line adaptor, it is determined in the step S106 that the toner supply call to the management device has failed and the process proceeds to a step S110 to perform these steps. In the step S110, the retrial counter in NV-RAM is decremented by one. In a step S111, the retrial counter value is checked, and if the value is non-zero, indicating that the information call has not reached the predetermined three trials, the process returns to the step S105. The toner supply call message is again reported to the line adaptor like an initial report. The above described steps are repeated. When the retrial counter value is “0,” the process as described in FIG. 35 is terminated.

Before the retrial counter value reaches “0,” if it is determined in a step S106 that the toner supply call to the management device is successful, in a step S107, the toner supply call completion flag in the NV-RAM is set to “1.” In a step S108, the post call paper counter flag in the NV-RAM is initialized to “0” while the retrial counter value is initialized to “0” in a step S109. The process then terminates.

Referring to FIG. 36, a flow chart illustrates steps involved in a prior art process of normal image transfer paper supply. The controller CPU in the image forming process increments the post call paper counter by one upon detecting that an image has been normally formed on a sheet and that the sheet has been outputted outside the device at the situation detection unit. FIG. 37 is a flow chart illustrating steps involved in a process by the controller CPU in the image forming device under the full toner condition. The controller CPU of the image forming device resets the toner supply call completion flag to “0” in the NV-RAM upon detecting the toner full condition at the situation detection unit after the toner bottle replacement. In the above described remote management system, while the image forming device at the device user side is reporting the situational information such as abnormal conditions and preventive alerts to the management device with or without an intermediary unit or a line adaptor, if its own main power is turned OFF and then ON by the operation of the device user, the above communication is interrupted. Unless the same condition occurs, the above interrupted communication cannot be re-established in the conventional systems. For example, if the above main power is turned OFF and ON by the device user during the toner supply call, since the toner supply call is interrupted, the toner supply call is not immediately performed unless the toner near end is again detected. Furthermore, since the user knows that abnormal conditions may be reset or corrected by turning the main power supply off and on, when an abnormal condition message is displayed on an operation unit, the user often turns the main power off and on.

When a condition information from an intermediate device or an image forming device is interrupted, the management device sometimes fails to receive the information in a normal manner. For example, if a supply call is interrupted, the supply call information is not received as usual. In this case, the supply order is not performed. On the other hand, even if the condition information from an intermediate device or an image forming device is interrupted, the management device sometimes correctly receives the information. For example, even if a supply call is interrupted, the supply call is correctly received. Accordingly, the supply order is performed. However, after correctly receiving the information, if the same condition occurs again at the image forming device side and the corresponding condition is received, the same information is received in a duplicated manner. For example, the identical supply call is received in a duplicated manner, and the same supply is ordered twice.

For the above reasons, it remains desired that while the communication device of an image forming device is performing to transmit. The condition information such as malfunction and unusual condition to an external unit, even if the communication is interrupted by turning off its main power supply, the transmission is resumed after its main power is turned ON.

### SUMMARY OF THE INVENTION

In order to solve the above and other problems, according to a first aspect of the current invention, a method of communicating, including the steps of detecting one of a predetermined set of events at a first device; setting a communication in-progress flag to a in-progress status prior to reporting to a second device; transmitting a report on the detected event from the first device to the second device; and determining whether or not the transmitting step has been interrupted based upon the communication in-progress flag.

According to a second aspect of the current invention, a communication device, including: an event detecting unit for detecting one of a predetermined set of events at a first device; a communication in-progress flag setting unit for setting a communication in-progress flag to a in-progress status prior to transmitting to a second device, the communication in-progress flag indicative of the transmission being in an in-progress status in case of interruption during the transmission; and an event information transmission unit connected to the event detection unit for transmitting a report on the detected event from the first device to the second device.

According to a third aspect of the current invention, a remote management system for remotely managing a plurality of communication devices via network, including: each of the communication devices further including: a managed communication unit for communicating with the management device; an event detecting unit for detecting one of a predetermined set of events at a first device; an event information transmission unit connected to the event detection unit and the managed communication unit for transmitting a report on the detected event to the management device via the managed communication unit, the event information transmission unit adding its own identity information to the report; and a communication in-progress flag setting unit connected to the event information transmission unit for setting a communication in-progress flag to a in-progress status before the event information transmission unit transmits the report, the communication in-progress flag indicative of the transmission being in an in-progress status in case of interruption during the transmission; the management device further including: a management communication unit for communicating with the communication devices; and a transmission result transmission unit for receiving via the management communication unit the report from one of the communication devices, in case that the reception is successful the transmission result transmission unit transmitting via the management communication unit a transmission result to one of the communication devices that has sent the report based upon the own identity in the report.

According to a fourth aspect of the current invention, a medium containing computer executable instructions for communicating, the instructions including the tasks of: detecting one of a predetermined set of events at a first device; setting a communication in-progress flag to a in-progress status prior to reporting to a second device; transmitting a report on the detected event from the first device to the second device; and determining whether or not the transmitting step has been interrupted based upon the communication in-progress flag.

### BRIEF DESCRIPTION OF THE DRAWINGS

FIG. 1 is a conceptual diagram illustrating an example of the construction of the remote management system according to the current invention.

FIG. 2A is a conceptual diagram illustrating a case where a request to the management apparatus 102 is generated at one of the managed apparatuses according to the current invention.

FIG. 2B is a conceptual diagram illustrating a case where a request to the managed apparatus 10 is generated by the management apparatus according to the current invention.

FIG. 3 is a conceptual diagram illustrating a preferred embodiment of the image forming apparatus management system according to the current invention.

FIG. 4 is a block diagram illustrating a preferred embodiment of the physical construction of the image forming apparatus.

FIG. 5 is a block diagram illustrating an example of the software configuration of the image forming apparatus according to the current invention.

FIG. 6A is a timing chart illustrating examples of the operations of the ENGRDY signal and PWRCTL signal at the start-up of the image forming apparatus.

FIG. 6B is a timing chart illustrating examples of the operations of the ENGRDY signal and the PWRCTL signal when transit to an energy-saving mode.

FIG. 6C is a timing chart illustrating the case where return from the energy-saving mode is performed.

FIG. 7 is a functional block diagram illustrating one preferred embodiment of the construction of the NRS.

FIG. 8 is a block diagram showing an example of the physical construction of the management apparatus.

FIG. 9 is a diagram illustrating an exemplary communication sequence in transmitting and receiving data among the management apparatus, the intermediate apparatus, and the image forming apparatus.

FIG. 10 is a diagram illustrating another exemplary communication sequence in the case where data is transmitted from the image forming apparatus to the management apparatus 102.

FIG. 11 is a table of the data structure examples or standards illustrating for determining a kind of abnormality.

FIG. 12 is a timing chart illustrating a communication sequence of events in a first preferred process of a successful toner supply call upon a toner near end event in the image forming device in the remote management system according to the current invention.

FIG. 13 is a timing chart illustrating a communication sequence of events in a second preferred process of a failed toner supply call upon a toner near end event in the image forming device in the remote management system according to the current invention.

FIG. 14 is a timing chart illustrating a communication sequence of events in a second preferred process of a failed toner supply call upon a toner near end event in the image forming device in the remote management system according to the current invention after twenty-four hours have elapsed following the activation of the 24-Hour timer.

FIG. 15 is a timing chart illustrating a communication sequence of events in a third preferred process of a main power OFF/ON during a toner supply call upon a toner near end event in the image forming device in the remote management system according to the current invention.

FIG. 16 is an exemplary e-mail illustrated to indicate that a toner supply call to the management apparatus has been failed.

FIG. 17 is a flow chart illustrating steps involved in a preferred process of handling a toner supply call from an image forming apparatus to a management apparatus in the remote management system according to the current invention.

FIG. 18 is a flow chart illustrating steps involved in a part of the preferred process of handling a toner supply call from an image forming apparatus to a management apparatus in the remote management system according to the current invention.

FIG. 19 is a flow chart illustrating steps involved in another part of the preferred process of handling a toner supply call from an image forming apparatus to a management apparatus in the remote management system according to the current invention.

FIG. 20 is a timing chart illustrating a communication sequence of events in a third preferred process of a toner supply call upon a toner near end event in the image forming device in the remote management system according to the current invention.

FIG. 22 is a flow chart illustrating steps involved in a preferred process of handling the black supply call from the image forming apparatus to the management apparatus in the remote system according to the current invention.

FIG. 23 is a flow chart illustrating steps involved in a preferred process of handling the red supply call from the image forming apparatus to the management apparatus in the remote system according to the current invention.

FIG. 24 is a flow chart illustrating steps involved in a part of the preferred process of handling the above black toner supply call from an image forming apparatus to a management apparatus in the remote management system according to the current invention.

FIG. 25 is a flow chart illustrating steps involved in a part of the preferred process of handling the above red toner supply call from an image forming apparatus to a management apparatus in the remote management system according to the current invention.

FIG. 26 is a flow chart illustrating steps involved in a preferred process of normal outputting of transfer paper according to the current invention.

FIG. 27 is a flow chart illustrating steps involved in a preferred process of resetting the black toner supply call complete flag according to the current invention.

FIG. 28 is a flow chart illustrating steps involved in a preferred process of resetting the red toner supply call complete flag according to the current invention.

FIG. 29 is a flow chart illustrating steps involved in a preferred process of setting the black toner supply call in-progress flag according to the current invention.

FIG. 30 is a flow chart illustrating steps involved in a preferred process of setting the red toner supply call in-progress flag according to the current invention.

FIG. 31 is a diagram illustrating an exemplary format of the toner supply call SOAP message in the HTTP message.

FIG. 32 is a table illustrating the data structure of the major components of the format.

FIG. 33 is a timing chart illustrating successful sequences of a toner supply call according to a prior art system.

FIG. 34 is a timing chart illustrating failed sequences of a toner supply call according to a prior art system.

FIG. 35 is a flow chart illustrating exemplary steps involved in the toner near end handling process by the controller CPU in the image forming device according to the conventional technology.

FIG. 36 is a flow chart illustrating steps involved in a prior art process of normal image transfer paper supply.

FIG. 37 is a flow chart illustrating steps involved in a process by the controller CPU in the image forming device under the full toner condition.

### DETAILED DESCRIPTION OF THE PREFERRED EMBODIMENT(S)

A specific description will now be given for preferred embodiments according to the present invention by referring to the drawings. First, a description will be given for an exemplary embodiment of a remote management system according to the present invention which manages an electronic apparatus to be managed (hereinafter referred to as a “managed apparatus”).

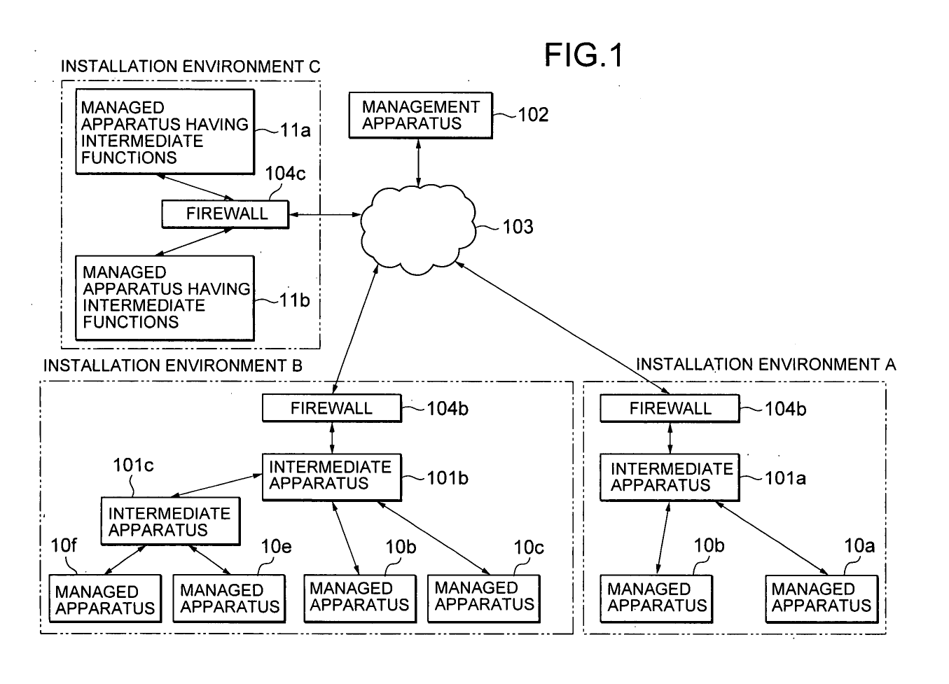

FIG. 1 is a conceptual diagram showing an example of the construction of the remote management system. The remote management system manages managed apparatuses 10 (10a, 10b, 10c, 10d, 10e, and 10f), which are image forming apparatuses such as a printer, a FAX apparatus, a digital copying apparatus, a scanner and a digital multi-functional apparatus, and communication apparatuses or electronic apparatuses such as network-based home appliances, automatic vending machines, medical equipment, power supply equipment, air conditioning systems and measuring systems of gas, water, electricity. The remote management system includes intermediate apparatuses 101 (101a, 101b, and 101c) that serve as remote management intermediate apparatuses which are connected with the managed apparatuses 10 via a local area network (LAN) external apparatuses. The managed apparatuses 10 are connected when they are seen from the managed apparatuses 10. Further, the remote management system includes a management apparatus 102 that functions as a server connected to the intermediate apparatuses 101 via, for example, the Internet 103. An alternative network such as a public line may also be used. In this way, the management system 102 remotely manages each of the managed apparatuses 10 via the intermediate apparatuses 101 in a centralized manner. The intermediate apparatuses 101 and the managed apparatuses 10 form various hierarchical structures in accordance with environment in which they are used.

For example, an installation environment A as shown in FIG. 1 has a simple structure where the intermediate apparatus 101a, which can establish direct connection with the management apparatus 102 by Hyper Text Transfer Protocol (HTTP), the intermediate apparatus 101a is connected to the managed apparatuses 10a and 10b. On the other hand, in an installation environment B as shown in FIG. 1, four managed apparatuses 10 (10c, 10d, 10e, and 10f) are installed. If only one intermediate apparatus 101 is installed, the processing load becomes heavy on the apparatus. For this reason, in the installation environment B, a hierarchical structure is formed. The intermediate apparatus 101b, which can establish direct connection with the management apparatus 102 by HTTP, is connected to another intermediate apparatus 101c, and the intermediate apparatus 101c is further connected to the managed apparatuses 10e and 10f. In this case, information transmitted from the management apparatus 102 for remotely managing the managed apparatuses 10e and 10f arrives at the managed apparatus 10e or 10f via the intermediate apparatus 101b and the intermediate apparatus 101c, which is a lower level node of the intermediate apparatus 101b.

In addition, as in an installation environment C, managed apparatuses 11a and 11b having intermediate functions (hereinafter also simply referred to as “managed apparatus”). The managed apparatuses 11a and 11b having the functions of an intermediate apparatus 101 may be connected to the management apparatus 102 via the Internet 103 without an intermediate apparatus. It is also possible to further connect a managed apparatus that is equivalent to the managed apparatus 10 to the managed apparatus 11 having intermediate functions, although the diagram fails to show such an arrangement.

Further, it should be noted that firewalls 104 (104a, 104b and 104c) are installed in the respective environments A, B and C for security. For example, the firewalls 104 are formed by proxy servers. In addition, it is also possible to connect a terminal unit such as a personal computer and an electronic apparatus (external apparatus) to each of the managed apparatuses 10 and 11 via a LAN. In such a remote management system, the intermediate apparatuses 101 run an application program for controlling and managing the managed apparatuses 10 that are connected with the intermediate apparatuses 101.

The management apparatus 102 installs an application program for controlling and managing each of the intermediate apparatuses 101 and for further controlling and managing the managed apparatuses 10 via the intermediate apparatuses 101. Each of the nodes in the remote management system, including the managed apparatuses 10, is capable of transmitting a “request” by remote procedure call (RPC) for processing in accordance with a method of the application program installed in each node and obtaining or receiving a “response” that is the result of the requested process by the RPC. The details will be described later.

That is, the intermediate apparatuses 101 or the managed apparatuses 10 connected thereto are generating a request to the management apparatus 102, transmitting the request to the management apparatus 102, and obtaining the response to the request. Similarly, the management apparatus 102 is generating a request, transmitting the same to the intermediate apparatuses 101 and obtaining the response to the request. The above requests include a request for causing the intermediate apparatuses 101 to transmit various other requests to the managed apparatuses 10 and to obtain responses from the managed apparatuses 10 via the intermediate apparatuses 101. Furthermore, in order to implement the RPC, well known communication protocols, techniques, specifications and the like are used and include SOAP (Simple Object Access Protocol), HTTP, FTP (File Transfer Protocol), COM (Component Object Model), and/or CORBA (Common Object Request Broker Architecture).

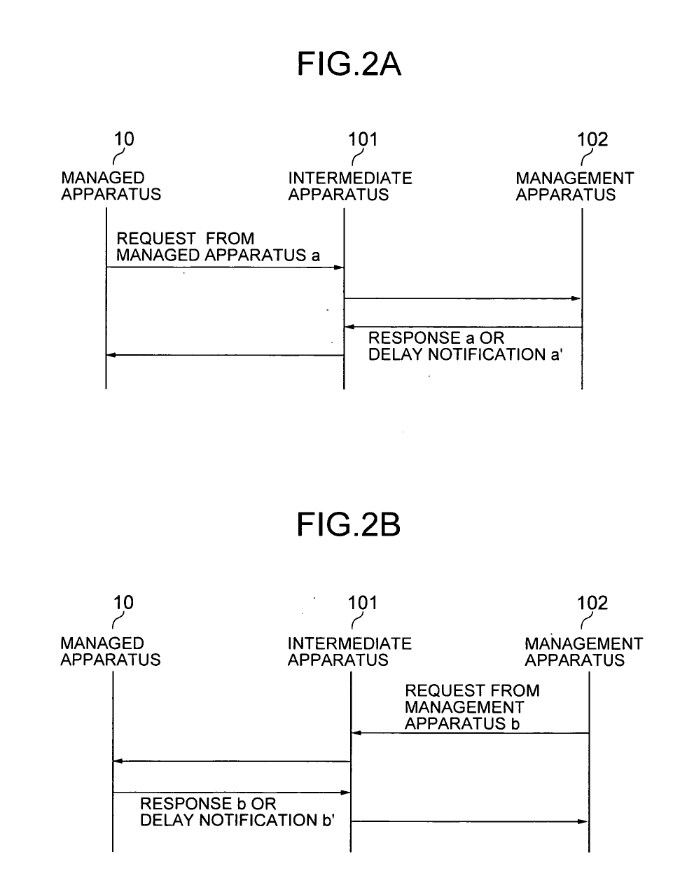

FIGS. 2A and 2B are conceptual diagrams illustrating data transmission and reception models of the above-mentioned transmission and reception. FIG. 2A illustrates a case where a request to the management apparatus 102 is generated at one of the managed apparatuses 10. The model in this case is as follows: the managed apparatus 10 generates a “request from the managed apparatus a”, and the management apparatus 102, receiving the request via the intermediate apparatus 101, returns a “response a.” The present invention also contemplates the case where the number of intermediate apparatuses 101 shown in FIG. 2A is two or more as in the installation environment B in FIG. 1. It should be noted that FIG. 2A shows the case where a “response delay notification a′” is returned in addition to the “response a”. This is because the management apparatus 102 is configured such that, when it is determined that the response to the request cannot be returned immediately in response to reception of the “request from the managed apparatus” via the intermediate apparatus 101, the response delay notification is transmitted and the connection is temporarily disconnected. The response to the request is then given later in a subsequent connection.

FIG. 2B illustrates a case where a request to the managed apparatus 10 is generated by the management apparatus 102. The model in this case is as follows: the management apparatus 102 generates a “request from the management apparatus b”, and the managed apparatus 10 which receives this request via the intermediate apparatus 101 returns a “response b.” In addition, similar to the case of FIG. 2A, in the case of FIG. 2B, a “response delay notification b′” is returned when the response cannot be returned immediately.

Next, a brief description will be given for an exemplary embodiment of the management apparatus 102 as shown in FIG. 1. The management apparatus 102 is constructed of a control unit formed by a CPU, a ROM, a RAM, a database, a modem, a proxy server, and the like. A detailed description of the construction will be given later.

Additionally, a brief description will be given for an exemplary embodiment of the intermediate apparatus 101 as shown in FIG. 1. The intermediate apparatus 101 is constructed of a CPU, a ROM, a RAM, a nonvolatile memory, a network interface card (hereinafter referred to as a “NIC”), and the like. A detailed description of the construction will be given later.

Further, for the managed apparatus 11 having intermediate functions, the above-mentioned units or components may be simply added to the managed apparatus 10 so as to realize the functions of the intermediate apparatus 101. However, it is also possible to realize the functions of the intermediate apparatus 101 by using hardware resources provided to the managed apparatus 10, such as a CPU, a ROM, a RAM and the like, and causing the CPU to execute an appropriate application or a program module.

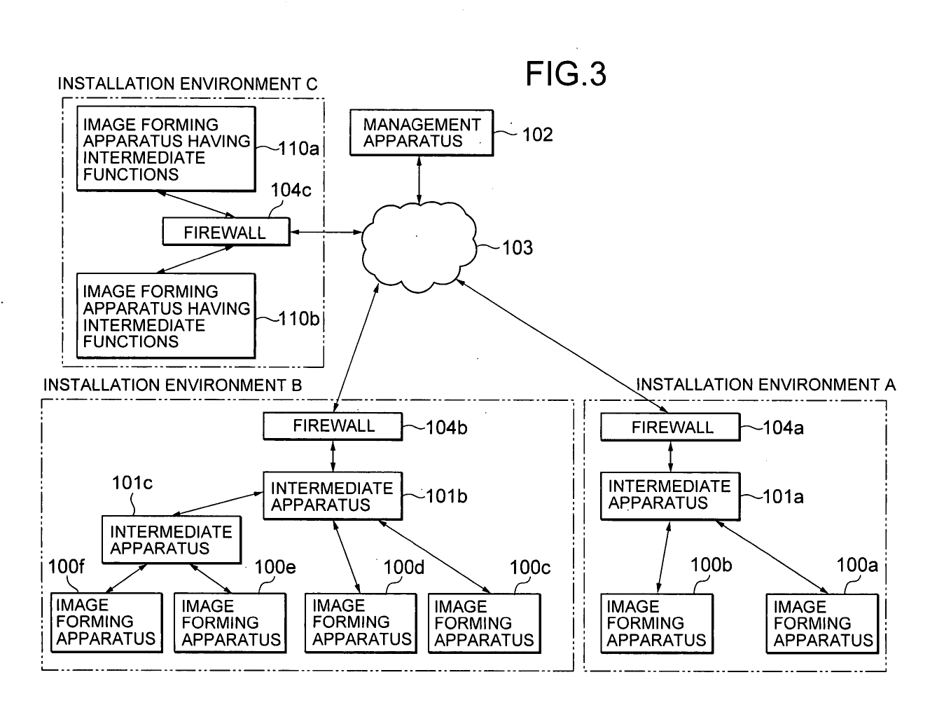

Next, a description will be given of an image forming apparatus management system according to the present invention. The remote management system has an image forming apparatus or electronic apparatus as the managed apparatus. Such image forming apparatus is a more specific example of the remote management system as shown in FIG. 1. FIG. 3 is a conceptual diagram illustrating a preferred embodiment of the image forming apparatus management system according to the current invention. A description of the structure of the system will be given only to the extent that FIG. 3 differs from FIG. 1 in that the managed apparatuses 10 are changed to image forming apparatuses 100 and the managed apparatuses 11 with intermediate functions are changed to image forming apparatuses 110 having intermediate functions (hereinafter also referred to as “image forming apparatuses”). The image forming apparatuses 100 are digital multi-functional apparatuses having functions of devices such as a copying machine, facsimile apparatus, scanner, and the like and functions for communicating with an external apparatus. The image forming apparatuses 100 install an application program for providing services relating to the above-mentioned functions. In addition, the image forming apparatuses 110 having the intermediate functions are the image forming apparatuses 100 having the functions of the intermediate apparatuses 101.

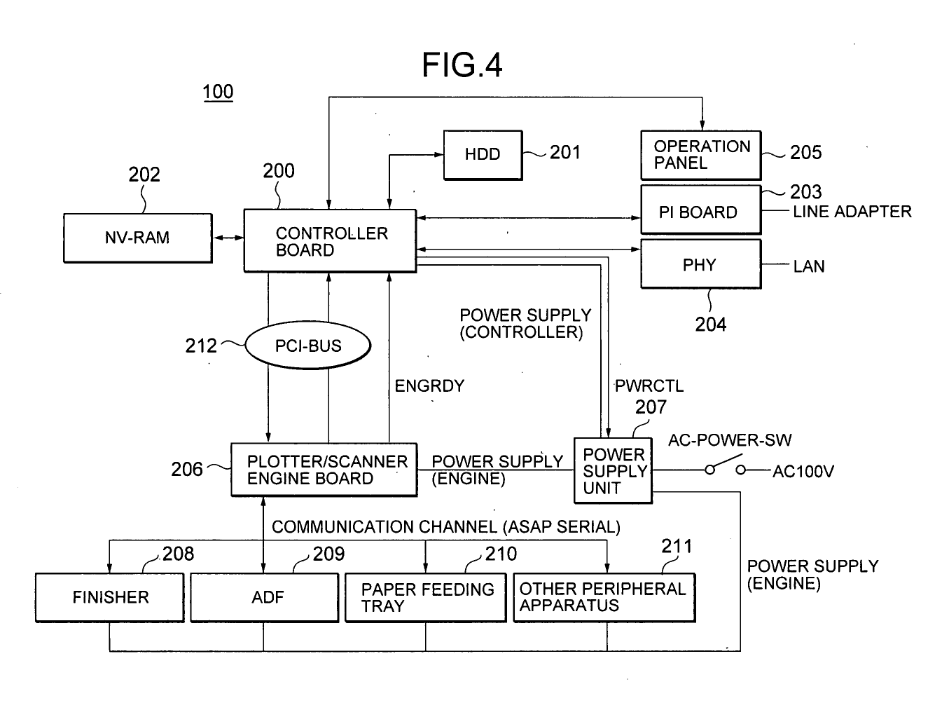

Referring to FIG. 4, a description will be given for a preferred embodiment of the image forming apparatus 100 according to the current invention. FIG. 4 is a block diagram illustrating a preferred embodiment of the physical construction of the image forming apparatus 100. As shown in FIG. 4, the image forming apparatus 100 includes a controller board 200, a HDD (hard disk drive) 201, a NV-RAM (nonvolatile RAM) 202, a PI (personal interface) board 203, a PHY (physical media interface) 204, an operation panel 205, a plotter/scanner engine board 206, a power supply unit 207, a finisher 208, an ADF (automatic document feeder) 209, a paper feeding tray 210, and other peripheral apparatus 211. Each of these units is a hardware resource of the image forming apparatus 100.

The controller board 200 corresponds to a control means. The controller 200 includes a CPU (hereinafter also referred to as a “controller CPU”), a ROM, a RAM and the like and controls each function via a PCI-BUS (Peripheral Components Interconnect-Bus) 212. The RAM provided in the controller board 200 is a volatile storing means that stores information when power is supplied from the power supply unit 207. The HDD 201 is a nonvolatile storing means or a recording medium that stores information or data irrespective of the power supply status from the power supply unit 207. The NV-RAM 202 is a nonvolatile storing means and may be realized by using nonvolatile memory such as EEPROM, flash memory, and nonvolatile RAM on which RAM and a backup circuit using a battery are integrated. The PI board 203 and the PHY 204 correspond to a communication means and are for external communication. For example, a communication board or the like corresponds to the PI board 203 and the PHY 204. The PI board 203 includes an interface conforming to the RS485 standard and is connected to a public line via a line adapter. Examples of the public line are fixed telephone lines such as an analog circuit, an ADSL circuit, a digital circuit (ISDN circuit), and a circuit using optical fiber: and wireless phone lines such as mobile phone lines and PHS lines. The PHY 204 is an interface for communicating with another electronic apparatus or a terminal unit such as a personal computer via a LAN. The operation panel 205 is an operation means including an operation part having various operation input keys which are also referred to as operation switches or operation buttons and a display unit having a character display portion such as an LCD or a CRT. An ENGRDY in FIG. 4 is a signal line for informing the controller board 200 that various initial settings of an engine unit or plotter/scanner engine board 206 are completed and that the transmission and reception of a command to and from the controller board 200 are ready. In addition, a PWRCTL is a signal line for controlling power supply to the engine unit by the controller board 200. The operations of the above-mentioned signal lines will be further described later.

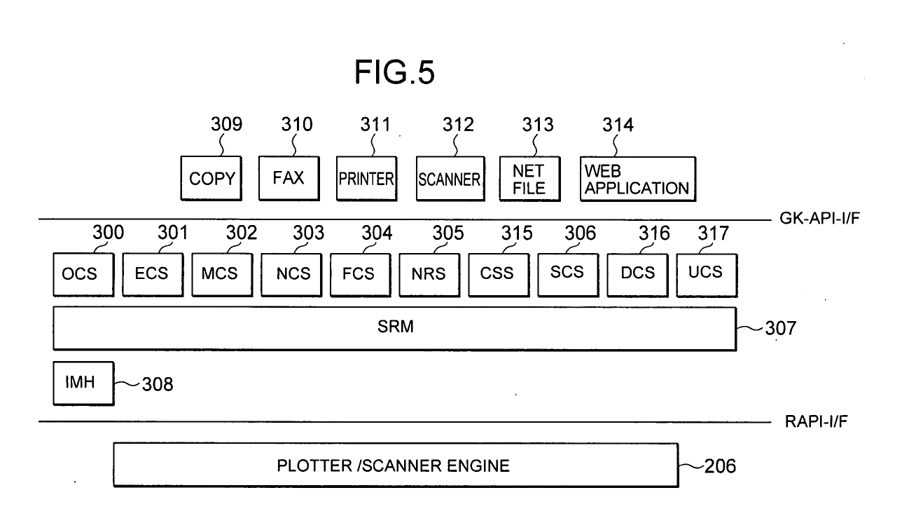

Next, referring to FIG. 5, a description will be given for a preferred embodiment in a software configuration of the image forming apparatus 100. FIG. 5 is a block diagram illustrating an example of the software configuration of the image forming apparatus 100 according to the current invention. The software configuration of the image forming apparatus 100 is formed by an application module upper layer, a service module middle layer, and a versatile OS lower layer. Programs forming the software are stored in the HDD 201 or the RAM on the controller board 200, are read out according to need, and executed by the controller CPU on the controller board 200. Also, the programs may be stored in a recording medium such as an optical disk (for example, a CD-ROM, a CD-R, a DVD-R, and a DVD-ROM), a magneto optical disk (for example, an MO), a flexible disk, and the like.

The controller CPU implements various functions including an abnormality information generation means, an abnormality information transmission means, an abnormality transmission in-progress setting means, a transmission result determination means, an abnormality transmission in-progress resetting means, a transmission failure notification means, a notification complete setting means, a notification disabling means, a notification complete resetting means, a notification enabling means, a timer means and an abnormality-type determination means.

Among the above-mentioned functions, those functions relating to communication with the management apparatus 102 are realized differently between the image forming apparatuses 100 and the image forming apparatuses 110. That is, in the case of the image forming apparatuses 110, the image forming apparatuses 10 are provided with the functions of the intermediate apparatuses 101. Thus, it is possible to for the image forming apparatuses 110 to realize the functions relating to communication with the management apparatus 102 by executing the corresponding program by the controller CPU. On the other hand, in the case of the image forming apparatuses 100, it is possible to realize the functions relating to communication with the management apparatus 102 by executing the corresponding program by the controller CPU and by using the intermediate apparatuses 101. Additionally, the image forming apparatus 100 is provided with a sensor in the engine unit, which includes a scanner engine and a plotter engine (image formation means). The sensor is for detecting an event such as abnormality.

The service module layer includes an operation control service (OCS) 300, an engine control service (ECS) 301, a memory control service (MCS) 302, a network control service (NCS) 303, a FAX control service (FCS) 304, a new remote service (NRS) 305, a system control service (SCS) 306, a system resource manager (SRM) 307, an image memory handler (IMH) 308, a customer support system (CSS) 315, a delivery control service (DCS) 316, and a user control service (UCS) 317. Also, the application module layer includes a copy application 309, a FAX application 310, a printer application 311, a scanner application 312, a Net File application 313, and a web application 314. Further, the versatile OS layer installs a versatile OS 320.

A more detailed description of the above-mentioned modules and applications will be given below. The OCS 300 is a module for controlling the operation panel 205. The ECS 301 is a module for controlling the engine unit such as the hardware resources. The MCS 302 is a module for performing memory control. For example, the MCS 302 obtains and releases image memory, and uses the HDD 201. The NCS 303 is a module for performing an intermediate process between a network and each application program in the application module layer. The FCS 304 is a module for performing facsimile transmission and reception, facsimile reading, facsimile reception and printing, and the like. The SCS 306 is a module for the activation and deactivation management of each application program in the application module layer based upon the contents of a command. The SRM 307 is a module for performing system control and resource management. The IMH 308 is a module for managing memory which temporarily stores image data. The CSS 315 is a module for converting data upon transmitting and receiving the data over a public line. The CSS 315 is a module that organizes functions related to the remote management over the public line. The DCS 316 is a module for transmitting and receiving an image file or the like stored (to be stored) in the HDD 201 or the memory on the controller board 200 by using SMTP (Simple Mail Transfer Protocol) or FTP (File Transfer Protocol). The UCS 317 is a module for managing user information, such as destination information and address information that are registered by a user of the apparatus.

The copy application 309 is an application program for realizing copy service. The FAX application 310 is an application program for realizing FAX service. The printer application 311 is an application program for realizing printer service. The scanner application 312 is an application program for realizing scanner service. The Net File application 313 is an application program for realizing Net File service. The web application 314 is an application program for realizing web service.

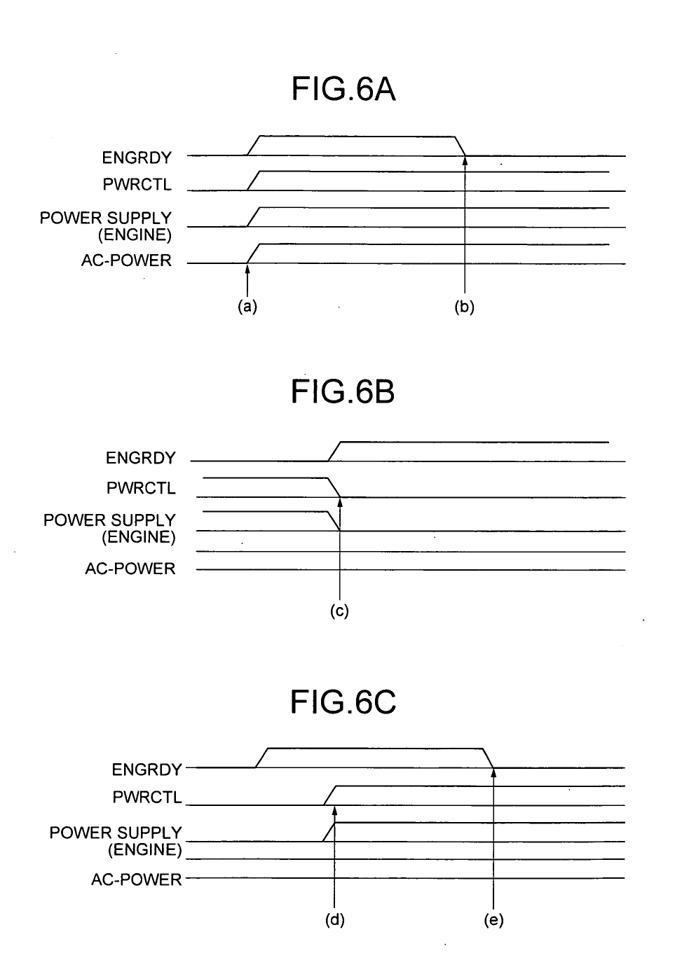

Referring to FIGS. 6A, 6B and 6C, a description will be given of the operations of the above-mentioned ENGRDY signal and PWRCTL signal. FIG. 6A shows examples of the operations of the ENGRDY signal and PWRCTL signal at the start-up of the image forming apparatus 100. When a main power supply switch (AC-POWER-SW) is turned ON at a point (a) in FIG. 6A and power is supplied to the power supply unit or main power supply 207 from a power supply part of an AC 100V simultaneously the ENGRDY signal becomes HIGH. In this state, communication with the engine unit cannot be performed because initial setting of the engine unit is not completed. Communication with the engine unit becomes possible when initial setting of the engine unit is completed after a predetermined amount of time and the ENGRDY signal becomes LOW as indicated by a point (b) in FIG. 6A.

Next, FIG. 6B shows examples of the operations of the ENGRDY signal and the PWRCTL signal in transition to an energy-saving mode. To enter into the energy-saving mode, the PWRCTL signal is turned OFF by the controller board 200. Simultaneously, power supply to the engine unit from the power supply unit 207 is stopped. Based on this, the ENGRDY signal becomes HIGH and transition to the energy-saving mode is performed.

Next, FIG. 6C illustrates the case where return from the energy-saving mode is performed. FIG. 6C shows examples of the operations of the ENGRDY signal and the PWRCTL signal in returning from the energy-saving mode to an ON-state. Upon returning from the energy-saving mode of FIG. 6B, the PWRCTL signal is turned ON by the controller board 200 as indicated by a point (d) in FIG. 6C. Simultaneously, power is supplied to the engine unit from the power supply unit 207. However, as shown in FIG. 6A, the ENGRDY signal remains HIGH until the initial setting of the engine unit is completed. When the initial setting is attained, communication with the engine unit is enabled, and the ENGRDY signal becomes LOW as indicated by a point e in FIG. 6C.

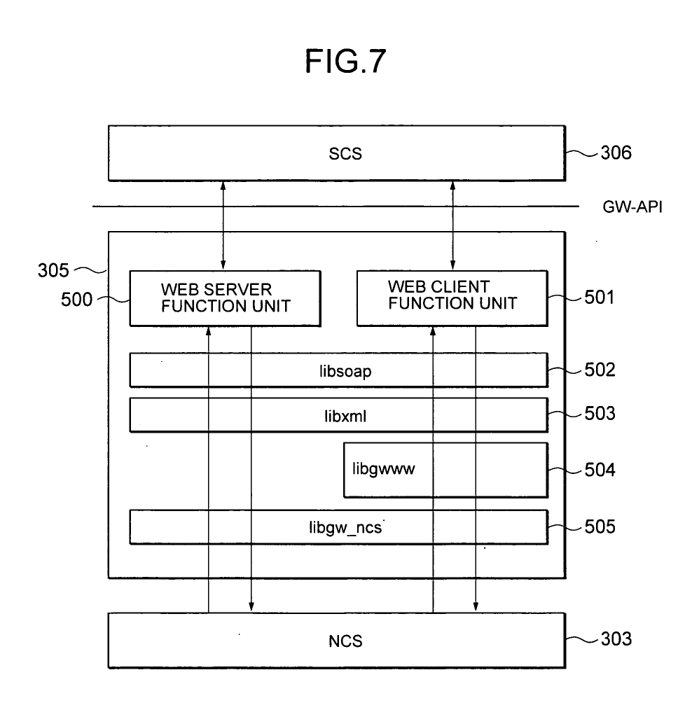

Next, referring to FIG. 7, a further description will be given for preferred embodiment of the NRS 305, which is included in the software of the image forming apparatus 100. FIG. 7 is a functional block diagram illustrating one preferred embodiment of the construction of the NRS 305. As shown in FIG. 7, the NRS 305 performs processes between the SCS 306 and the NCS 303. A web server function part 500 performs a response process for a request received from the outside. The request may be, for example, a SOAP request according to the SOAP (Simple Object Access Protocol) described in a structured language such as the XML (Extensible Markup Language) format. The web client function part 501 performs a process of issuing a request to the outside. A libsoap 502 is a library that processes data in the SOAP format. A libxml 503 is a library that processes data described in the XML format. In addition, a libgwww 504 is a library that processes data in the HTTP format. A libgw_ncs 505 is a library that performs processes with respect to the NCS 303.

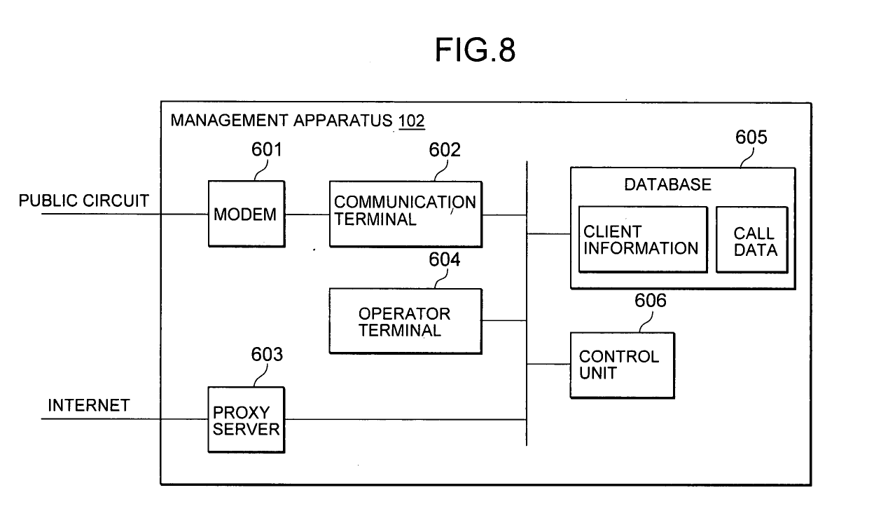

Next, referring to FIG. 8, a description will be given for a preferred embodiment of the management apparatus 102. FIG. 8 is a block diagram showing an example of the physical construction of the management apparatus 102. The management apparatus 102 includes a modem 601, a communication terminal 602, a proxy server 603, an operator terminal 604, a database 605, a control unit 606, and the like. The modem 601 communicates with the intermediate apparatus 101 or the image forming apparatus 110. For example, the user's destination is the image forming apparatus via a public line. The modem 601 respectively modulates and demodulates transmission data and reception data. The modem 601 serves as communication means together with the communication terminal 602, which will be described later. The communication terminal 602 controls communication carried out by the modem 601. The proxy server 603 performs security management and communication with the intermediate apparatus 101 or the image forming apparatus 110 on the user's end via the Internet. The proxy server 603 also serves as the communication means.

The operator terminal 604 accepts inputs of various data via an input device such as a keyboard when an operation is conducted thereon by the user. The input data includes client information such as IP addresses and telephone numbers that are used to communicate with the intermediate apparatus 101 or the image forming device 110 on the device user side. The database 605 exists in a storage unit such as a hard disk of a server that is not shown in the figure. The database 605 stores the IP addresses and the telephone numbers of the intermediate apparatus 101 and the image forming apparatus 110 of the each device user, data received from the above devices, data input from the operation terminal 604, and various data including the software programs according to the current invention. The control unit 606 is provided with a micro computer formed by a CPU, ROM, RAM and the like, that are not shown in the figure. The control unit 606 centrally controls the management apparatus 102. It is possible to realize various functions of the transmission result notification means according to the current invention by operating the CPU in accordance with the programs, carrying out the programs according to need and selectively using the modem 601, the communication terminal 602, or the proxy server 603.

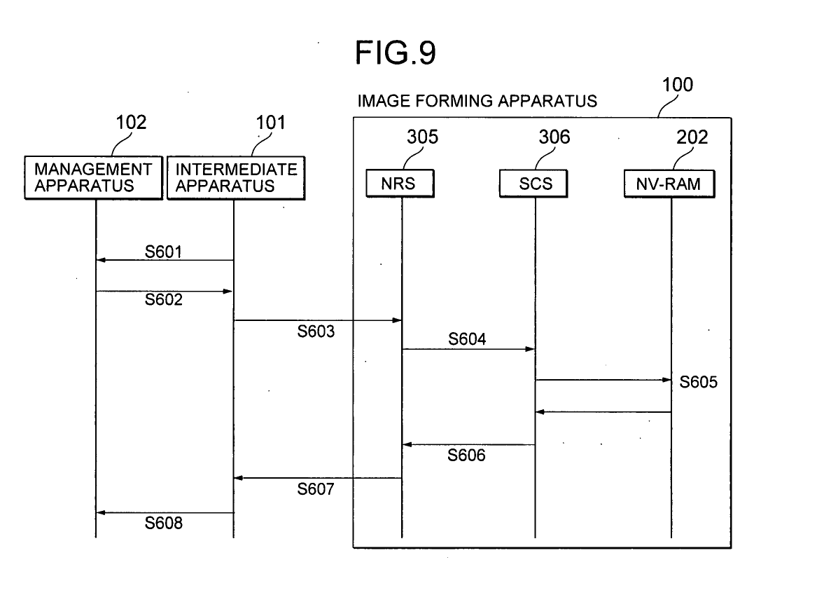

Referring to FIG. 9, based on the above-mentioned construction, a description will be given for an exemplary communication sequence in transmitting and receiving data in the image forming apparatus management system as shown in FIG. 3. Processes by the SCS 306 and the NRS 305, which are explained below, are actually carried out by operations of the controller CPU in accordance with the programs. However, for convenience of explanation, it is assumed that the processes are carried out by the programs. FIG. 9 is a diagram illustrating an exemplary communication sequence in transmitting and receiving data among the management apparatus 102, the intermediate apparatus 101, and the image forming apparatus 100. In this example, first, in step S601, the intermediate apparatus 101 polls to inquire as to whether or not there is a transmission request to the management apparatus 102. In other words, the intermediate apparatus 101 generates an HTTP message including a SOAP message for polling to which an identifier representing self-identification information is added. Then, the intermediate apparatus 101 transmits the HTTP message to the management apparatus 102. When the management apparatus 102 receives the HTTP message from the intermediate apparatus 101, the management apparatus 102 generates an HTTP message including a SOAP message representing an accounting counter data obtaining request and transmits the request to the intermediate apparatus 101. In step S602, the intermediate apparatus 101 is the transmitting source of the received SOAP message. On this occasion, the corresponding intermediate apparatus 101 is identified based on the identifier added to the SOAP message in the received HTTP message.

When the intermediate apparatus 101 receives the HTTP message from the management apparatus 102, the intermediate apparatus 101 generates a SOAP message representing the accounting counter data obtaining request based on the HTTP message and transmits the request to the NRS 305 of the image forming apparatus 100 that is connected to the same intermediate apparatus 101 in step S603. In step S604, the NRS 305 notifies the SCS 306 of the accounting counter data obtaining request in the SOAP message that is received from the intermediate apparatus 101. When the SCS 306 receives the notification of the accounting counter data obtaining request from the NRS 305, the SCS 306 reads data for the accounting counter stored in the NV-RAM 202 in step S605. Then, in step S606, the SCS 306 transmits the read data or response data of accounting counter to the NRS 305. When the NRS 305 receives the data of accounting counter from the SCS 306, the NRS 305 generates a SOAP message for accounting counter, representing the contents of the data, converts the received data into the XML format that is a structured language format, and transmits the message to the intermediate apparatus 101 in step S607. When the intermediate apparatus 101 receives the SOAP message for accounting counter from the NRS 305, the intermediate apparatus 101 generates an HTTP message based on the SOAP message and transmits the message to the management apparatus 102 in step S608. In this manner, transmission and reception of data are performed according to the above-mentioned communication sequence.

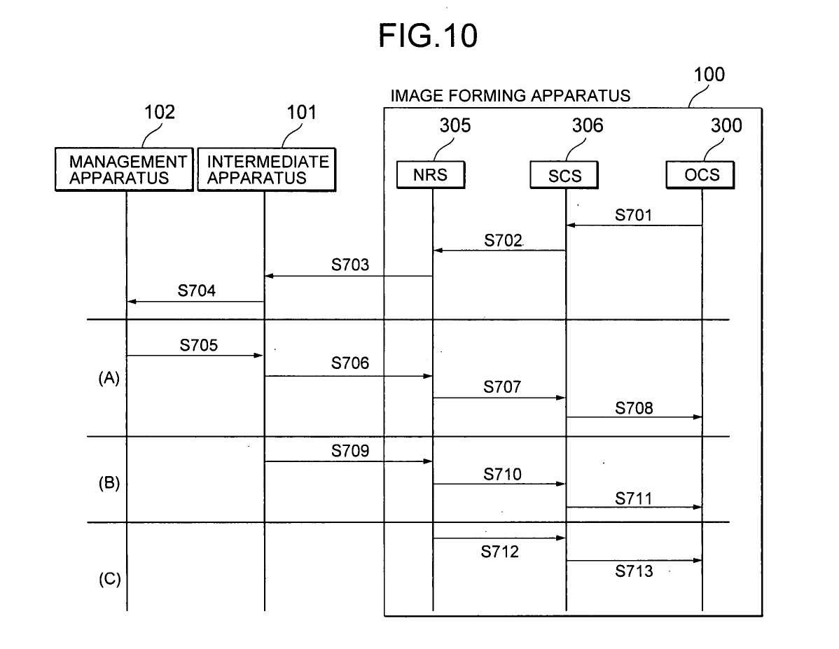

Next, referring to FIG. 10, a description will be given for an exemplary communication sequence in the case where, unlike the case shown in FIG. 9, data are transmitted to the management apparatus 102 from the image forming apparatus 100 via the intermediate apparatus 101. FIG. 10 is a diagram illustrating another exemplary communication sequence in the case where data is transmitted from the image forming apparatus 100 to the management apparatus 102. In this example, first, in step S701, the OCS 300 notifies the SCS 306 that an undiagramed user call key on the operation panel 205 is pressed down. When the SCS 306 receives from the OCS 300 the notification that the user call key is pressed down, the SCS 306 notifies the NRS 305 of a user call request in step S702. When the NRS 305 receives from the SCS 306 the notification of the user call request, the NRS 305 generates a SOAP message for the user call information on the user call and transmits the message to the intermediate apparatus 101 in step S703. When the intermediate apparatus 101 receives from the NRS 305 the SOAP message for user call, the intermediate apparatus 101 adds an identifier representing self-identification information to the SOAP message, further generates an HTTP message based on the SOAP message, and makes a user call with respect to the management apparatus 102. That is, in step S704, the intermediate apparatus 101 reports to the management apparatus 102 via the HTTP message including the user call SOAP message with the self-identifier.

Here, process patterns after the step S704 will be explained by dividing the patterns into (A), (B), and (C). First, in the pattern (A), the management apparatus 102 receives the HTTP message including the user call SOAP message from the intermediate apparatus 101 on the user's side. When the reception ends normally, the management apparatus 102 generates an HTTP message including a SOAP message representing the successful result of the user call and transmits the message to the reporting source intermediate apparatus 101 in step S705. On the other hand, when the reception does not end normally or ends abnormally, the management apparatus 102 generates an HTTP message including a SOAP message representing the result of the user call and transmits the message to the reporting source intermediate apparatus 101 also in the step S705.

When the intermediate apparatus 101 receives from the management apparatus 102 the HTTP message including the SOAP message representing the result of the call, in step S706, the intermediate apparatus 101 generates a SOAP message representing the result of the call based on the HTTP message and transmits the message to the NRS 305 of the image forming apparatus 100 whose user call key has been pressed down. When the NRS 305 receives from the intermediate apparatus 101 the SOAP message representing the result of the call, the NRS 305 interprets or determines the result of the call represented by the SOAP message and reports it to the SCS 306 in step S707. When the SCS 306 receives the result of the call, the SCS 306 transmits it to the OCS 300 in step S708. When the OCS 300 receives the result of the call from the SCS 306, in step S708, the OCS 300 displays a message representing the contents on a character display unit of the operation panel 205. That is, the displayed message is whether the user call has been successful or failed.

In the pattern (B), when the intermediate apparatus 101 determines that there is no response from the management apparatus 102 after a predetermined time period has elapsed, in step S709, the intermediate apparatus 101 generates a SOAP message representing the result or failure of the call and transmits the message to the NRS 305. When the NRS 305 receives the SOAP message representing the failed result of the call, in step S710, the NRS 305 interprets the failed result of the call described in the SOAP message and reports it to the SCS 306. When the SCS 306 receives the result of the call from the NRS 305, the SCS 306 transmits the result to the OCS 300 in step S711. When the OCS 300 receives the result of the call from the SCS 306, the OCS 300 displays the contents, on the character display unit of the operation panel 205 in step S711. That is, the message represents the failure of the user call.

In the pattern (C), when the NRS 305 determines that there is no response from the intermediate apparatus 101 after a specified time has elapsed, the NRS 305 reports the failed result of the user call to the SCS 306 in step S712. When the SCS 306 receives the result of the call from the NRS 305, the SCS 306 transmits it to the OCS 300 in step S713.

When the OCS 300 receives the result of the call from the SCS 306, in step S713, the OCS 300 displays the message contents, representing the failed user call on the character display unit of the operation panel 205. Here, in the plotter engine of the image forming apparatus 100, when a predetermined event such as an abnormality occurs, the image forming apparatus 100 detects it and processes it depending on the kind of detected events. Information serving as a standard for determining the kind of event is required.

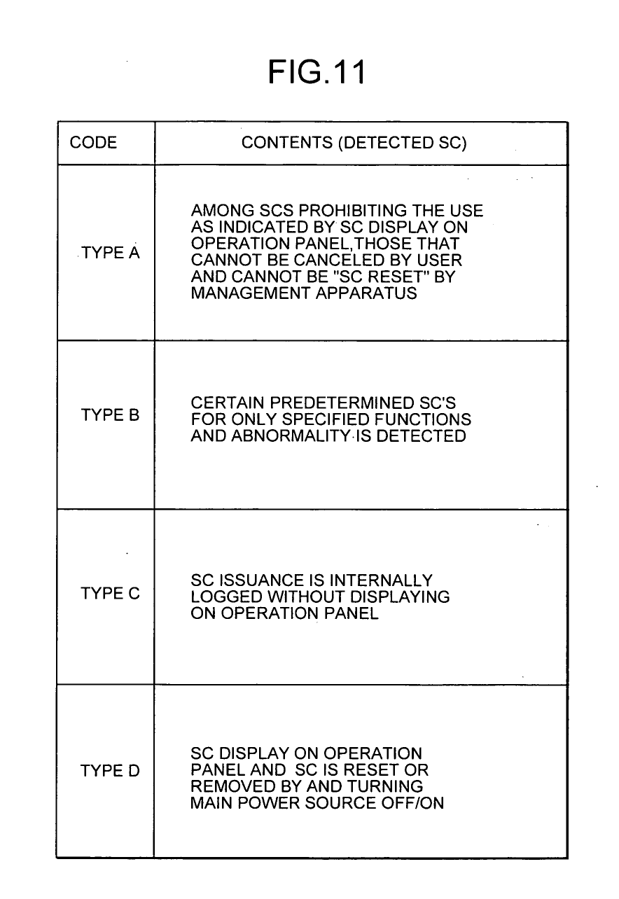

FIG. 11 is a table of the data structure examples or standards for determining a kind of abnormality. Here, “SC (service person call)” is equivalent to an “abnormality.” As shown in FIG. 11, the kind or type of event is determined according to the detected SC. A description will now be given for exemplary kinds of events.

Among SCs prohibiting the use of the apparatus, “Type A” represents a SC that cannot be solved by a user to use the apparatus and is displayed on the character display unit of the operation panel 205. “Type A” includes an event that does not allow “SC reset” by the management apparatus 102. For example, a SC is related to a repair of the system.

“Type B” represents a SC that does not allow the use of a specific predetermined function in which abnormality is detected. In normal use, a SC is not displayed on the character display unit of the operation panel 205. However, only when the specified function in which abnormality is detected is selected by a key operation on the operation panel 205, the SC is displayed on the character display unit. An exemplary type B SC occurs when a duplex mode is selected while a duplex unit is in an abnormal condition.

“Type C” represents a SC that is internally logged without any display on the character display unit of the operation panel 205. For example, when communication becomes impossible, the SC is the “type C.”

“Type D” represents a SC that makes the SC display on the character display unit of the operation panel 205 so as to prohibit the use of the image forming apparatus. However, the type D SC can be solved by an OFF/ON operation in which the main power supply of the apparatus is temporarily turned OFF and then turned ON again. Alternatively, the apparatus is reset by an operation of the software power supply key or a reboot key. There is also a case where the SC is detected again even after the main power supply is turned OFF and ON and the SC does not seem to be solved. For example, motor malfunction corresponds to the “type D.” The above reference or standard information for the determination is stored in a predetermined storage area of the NV-RAM 202 (or the HDD 201) in one preferred embodiment. Further, events of units are treated as different events such as an SC of the scanner engine and an SC of the plotter engine.

Next, a description will be given for a preferred process and embodiment of the image forming apparatus 100 and the image forming apparatus management system according to the current invention. That is, the processes according to present invention is control performed by the image forming apparatus 100 at the time of the occurrence of an abnormality.

As described above, the image forming apparatus 100 is provided with both the communication means corresponding to the public line and the network communication. Also, the image forming apparatus 100 is configured to serve as the target of remote management (remote service: RS) according to a customer support system method to communicate with the management apparatus 102 via the intermediate apparatus 101 and the public circuit. The image forming apparatus 100 is also configured to serve as the target of remote management according to a new remote service method to communicate with the management apparatus 102 via the intermediate apparatus 101 and the Internet 103. The image forming apparatus 110 is equipped with the functions of the intermediate apparatus 101. Accordingly, the image forming apparatus 110 is likewise configured to serve as the target of the remote management according to the customer support system method to communicate with the management apparatus 102 via the public circuit. Similarly, the image forming apparatus 10 is also configured to serve as the target of the remote management according to the new remote service method to communicate with the management apparatus 102 via the Internet 103.

The image forming apparatuses 100 and 110 are equipped with the programs such as the CSS 315 corresponding to the customer support system method and the NRS 305 corresponding to the new remote service method for transmitting information representing the state of the engine unit and for reporting to the management apparatus 102 event information when an event-causing report occurs in the hardware resources such as the engine unit.

For convenience of explanation, a description will be given for the processes according to the present invention where the image forming apparatus 100 uses the NRS 305. Only a scanner engine and a plotter engine are considered to be an engine unit. It should be noted that the processes according to the present invention may also be performed by the image forming apparatus 100 using the CSS 315. In addition, the processes according to the present invention may also be performed by the image forming apparatus 110 using the NRS 305 or the CSS 315.

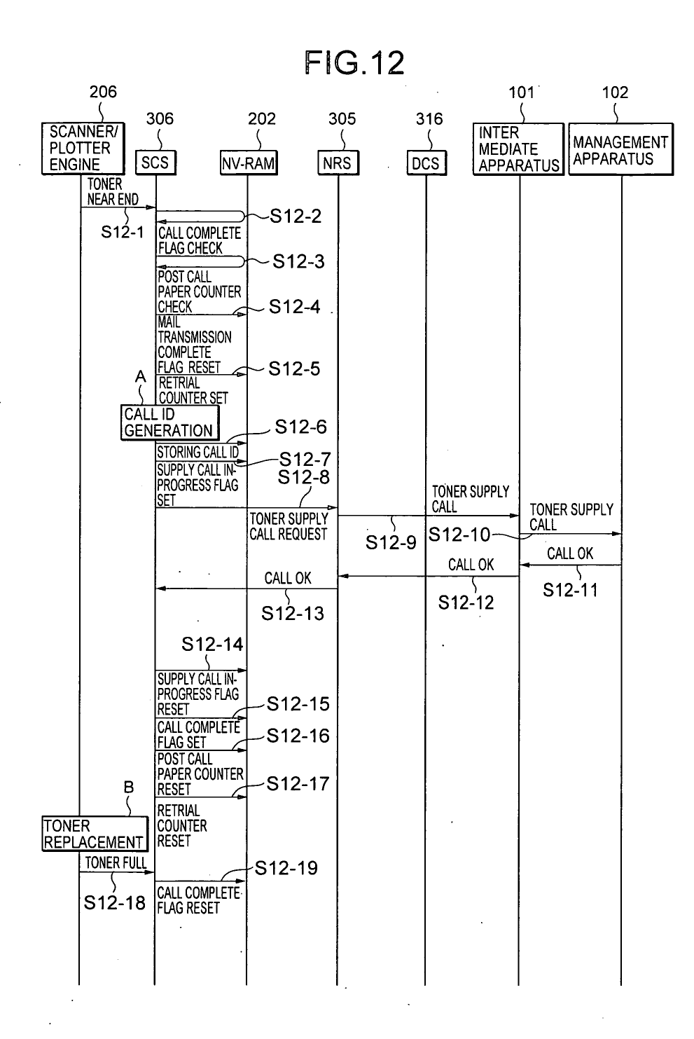

Now referring to FIG. 12, a timing chart illustrates a communication sequence of events in a first preferred process of a successful toner supply call upon a toner near end event in the image forming device 100 in the remote management system according to the current invention. Although the following processes by SCS306, NRS305 and DCS316 are carried out by the CPU according to the corresponding software program, for the sake of convenience, it is treated that the software programs themselves execute the processes. The image forming apparatus or device 100 is equipped with an event detecting unit or detector both in the scanner engine and the plotter engine. For example, as shown in FIG. 12, when a toner near end occurs in the plotter engine, a toner level goes below a predetermined level in the toner bottle. The corresponding detector detects the above toner near end event and reports the detection result to the SCS 306 on the controller board 200 in a sequence S12-1. Upon receiving the toner near end detection result from the plotter engine, the SCS 306 determines that the toner near end occurred in the plotter engine and checks the value of the toner supply call complete flag and the post call paper counter in the non-volatile random access memory (NV-RAM) 202 in sequences S12-2 and S12-3. If the toner supply call complete flag has been reset to “0” and the post call paper counter contains a value over “1000,” the SCS 306 determines that the toner supply call issuance condition has been satisfied. On the other hand, if the toner supply call complete flag has not been reset to “0” or no toner supply call has been made, the above condition is ignored even with the post call paper counter containing a value over “1000.” After the mail transmission complete flag in the NV-RAM 202 is reset to “0” in a sequence S12-4, the toner supply retrial counter in the NV-RAM 202 is set to “3” in a sequence S12-5. Furthermore, the SCS 306 generates a call ID for identifying a particular toner supply call in an event A and stores the call ID in the NV-RAM 202 in a sequence S12-6. Each of the toner supply calls is an automatic report of the toner supply call information to notify a toner bottle order upon a toner near end. After the SCS 306 sets the supply call in-progress flag to “1” in NV-RAM 202 in a sequence S12-7, the SCS 306 transmits to the NRS 305 a toner supply call request in a sequence S12-8. In the above transmission, the device information for identifying the image forming apparatus 100 and the call ID stored in the NV-RAM 202 are added to the toner supply call request. In addition, the message, “toner supply call” is displayed on the character display on the operation panel 205.

Still referring to FIG. 12, the NRS 305, the intermediate apparatus 101 and the management apparatus 102 perform the following tasks. Upon receiving the toner supply call request, the NRS 305 generates a SOAP message for a toner supply call to notify the toner bottle order and transmits it to the intermediate apparatus 101 in a sequence S12-9. The SOAP message includes the device information and the call ID that have been added to the toner supply call request. Upon receiving the toner supply call SOAP message from the NRS 305, the intermediate apparatus 101 adds its own intermediate apparatus identifying information to the SOAP message and generates a HTTP message based upon the SOAP message. The intermediate apparatus 101 performs a toner supply call to the management apparatus 102 via the Internet 103 in a sequence S12-10. That is, the intermediate apparatus 101 automatically transmits the HTTP message including the toner supply call SOAP with the self intermediate apparatus identifier to the management device 102 at the service center via the Internet.

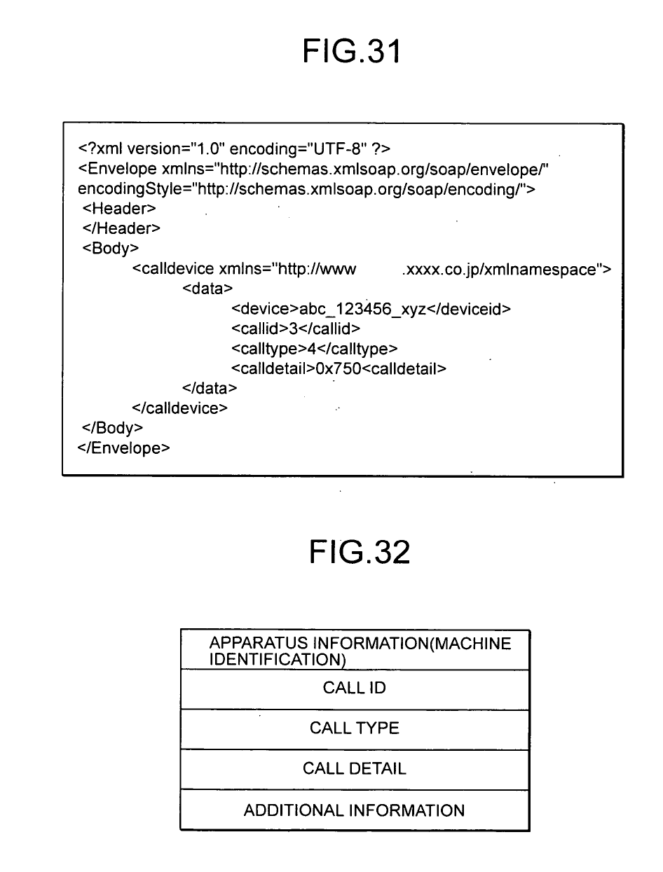

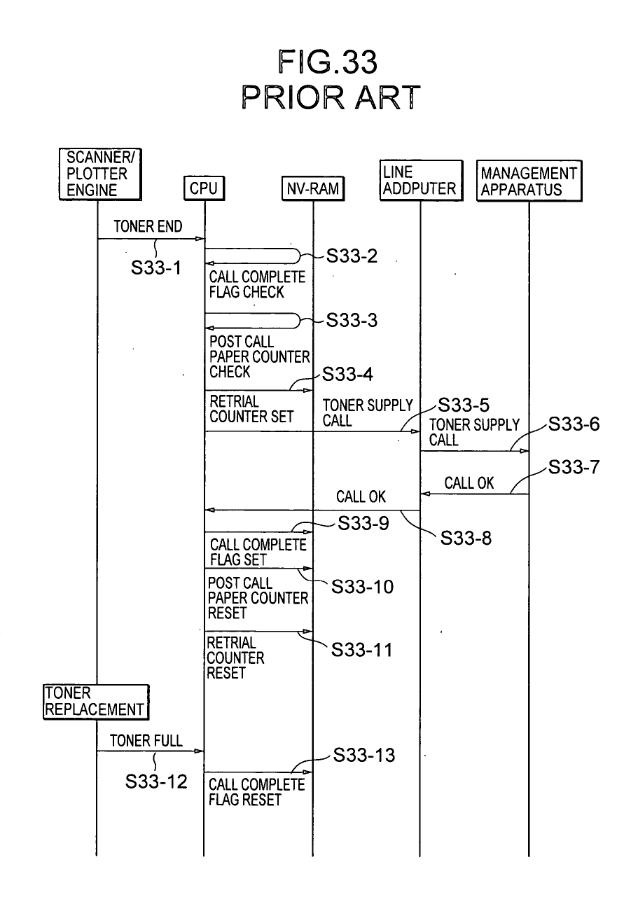

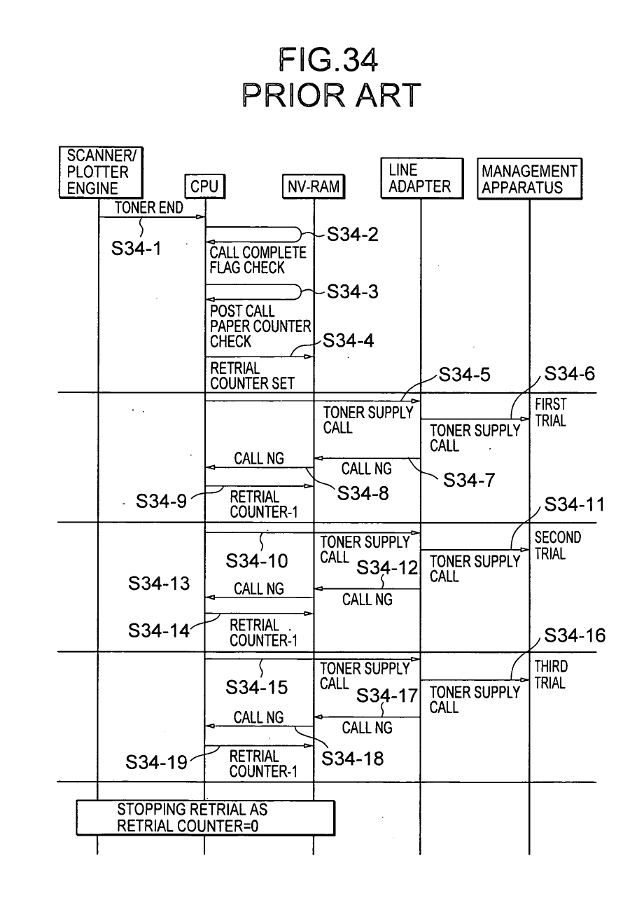

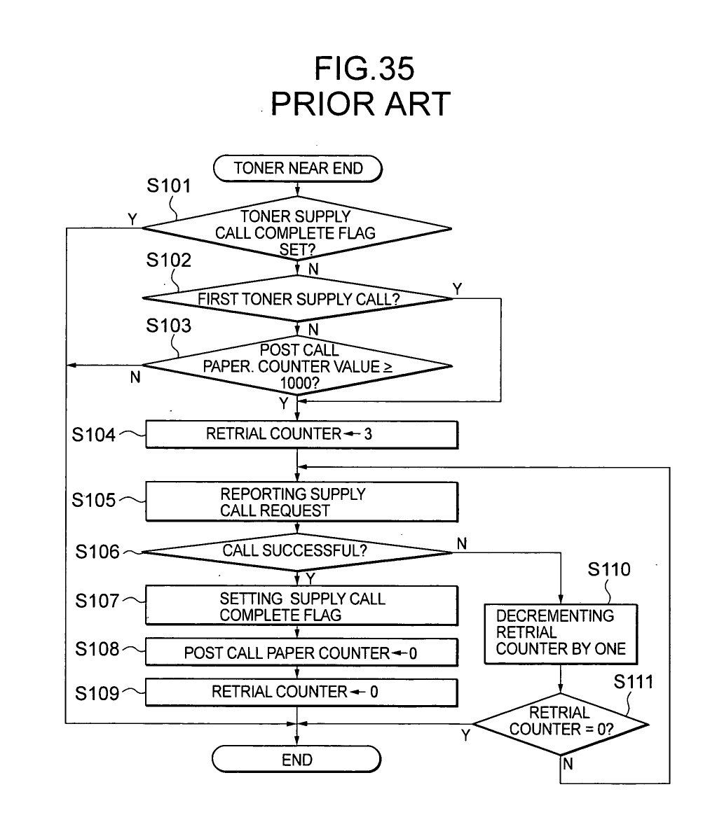

An exemplary format of the toner supply call SOAP message in the HTTP message is briefly described by referring to FIGS. 31 and 32. The above SOAP message does not have the intermediate device identifier. FIG. 31 illustrates an exemplary format of the toner supply call SOAP message in the HTTP message. FIG. 32 illustrates the data structure of the major components of the format. As illustrated in the figures, the toner supply call SOAP message includes device information for identifying the image forming apparatus 100 with the toner near end, an arbitrary call ID for identifying a toner supply call, a call type and additional information on call details. The first preferred embodiment does not include the information on the call type for identifying a type of a toner supply call. As additional information, jamming status or service call (SC), a counter value as well as the logged information of the image forming device 100 with the toner near end are added to the toner supply call SOAP message.

Referring back to FIG. 12, the management apparatus 102 performs the following tasks. Upon successfully receiving the HTTP message with the toner supply call SOAP message from the intermediate apparatus 101 at the user side, the management apparatus 102 generates a call OK SOAP message indicative of a successful reception of the HTTP message based upon the device information and the intermediate identifier that has been added to the SOAP message in the received HTTP message. The successful call OK SOAP message means that the toner supply call process has successfully processed. The management apparatus 102 then transmits the above generated SOAP message to the original intermediate apparatus 101 via the Internet 103 in a sequence S12-11. The original intermediate apparatus 101 is the one that had transmitted the HTTP message with the toner supply call SOAP message. The SOAP message or the toner supply call information from the received HTTP message is stored in a queue in the database 605. The stored information waits in the queue for the center operator to process the toner bottle order. The SOAP message content in the received HTTP message is further displayed at the display unit of the operator terminal 604 in order to notify the operator. Following the toner near end in the plotter engine of the image forming apparatus 100 that is connected to the reporting source of the intermediate apparatus 101, when the center operator confirms that a toner bottle has been requested by the display content on the display unit at the operator terminal 604, he or she orders the toner bottle. For example, a repair person is arranged to deliver a toner bottle to an installation location of the reporting source intermediate apparatus 101.

Upon receiving the HTTP message with the call OK SOAP message from the management apparatus 102 as a result of the toner supply call to the management apparatus 102, the intermediate apparatus 101 generates a call OK SOAP message based upon the HTTP message and transmits it to the NRS 305 of the image forming apparatus 100 with the toner near end event in a sequence S12-12. After receiving the call OK SOAP message from the intermediate apparatus 101, the NRS 305 reports to the SCS 306 the call OK indicative of the successfully completed toner supply call in a sequence S12-13. In response to the call OK from the NRS 305, the SCS 306 determines that the toner supply call to the management apparatus 102 has been successfully completed, and the SCS 306 displays the “toner supply call successful” message on the display unit of the operation panel 205. Subsequently, the SCS 306 resets the supply call in-progress flag to “0” in the NV-RAM 202 in a sequence S12-14 while the SCS 306 also sets the toner supply call complete flag to “1” in the NV-RAM 202 in a sequence S12-15. Furthermore, the SCS 306 resets the post call paper counter value and the retrial counter value to “0” in the NV-RAM 202 in sequences S12-16 and S12-17 so the two counters operates from “0.”

After the toner bottle is replaced in a plotter engine of the image forming apparatus 100 in an event B, a toner full event occurs. That is, the amount of toner is full in the toner bottle. The corresponding detector detects the toner full and reports it to the SCS 306 in a sequence S12-18. Upon receiving the toner full signal from the plotter engine, the SCS 306 resets the supply call complete flag to “0” in the NV-RAM 202 in a sequence S12-19 in order to perform a next supply call for a subsequent toner near end. However, a subsequent toner supply call is not performed unless the post call paper counter value reaches 1000.

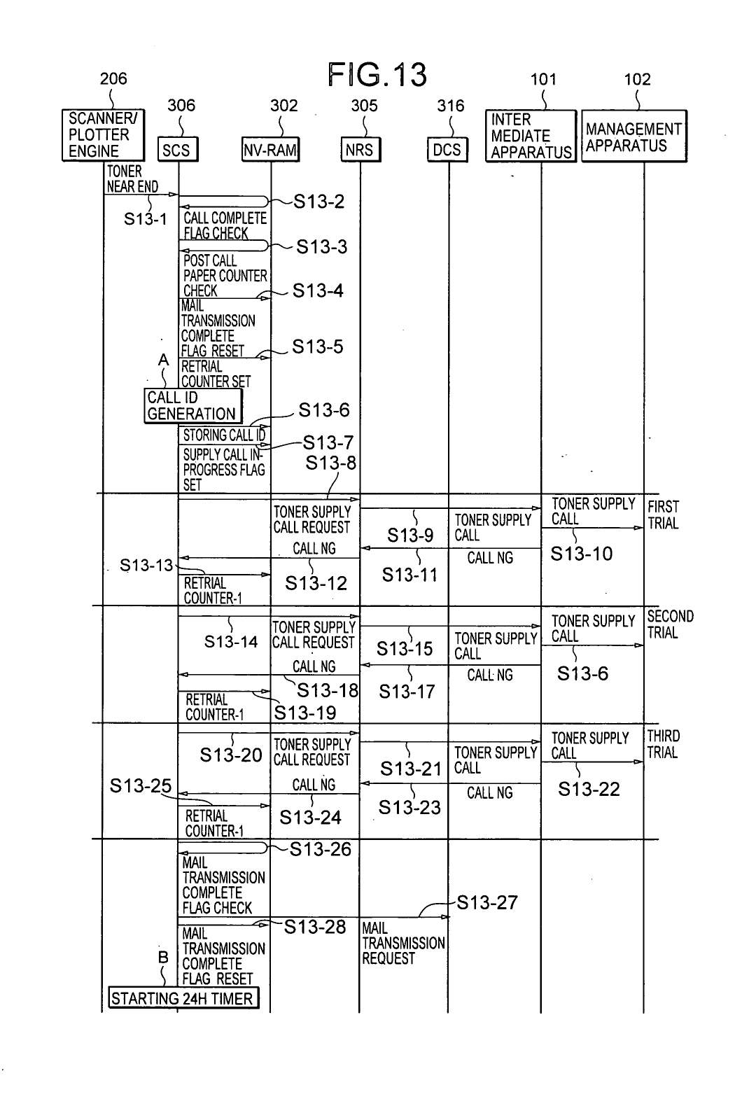

Now referring to FIG. 13, a timing chart illustrates a communication sequence of events in a second preferred process of a failed toner supply call upon a toner near end event in the image forming device 100 in the remote management system according to the current invention. When a toner near end occurs in the plotter engine, a toner level goes below a predetermined level in the toner bottle. The corresponding detector detects the above toner near end event and reports the detection result to the SCS 306 on the controller board 200 in a sequence S13-1. Upon receiving the toner near end detection result from the plotter engine, the SCS 306 determines that the toner near end occurred in the plotter engine and checks the value of the toner supply call complete flag and the post call paper counter in the non-volatile random access memory (NV-RAM) 202 in sequences S13-2 and S13-3. If the toner supply call complete flag has been reset to “0” and the post call paper counter contains a value over “1000,” the SCS 306 determines that the toner supply call issuance condition has been satisfied. On the other hand, if the toner supply call complete flag has not been reset to “0” or no toner supply call has been made, the above condition is ignored even with the post call paper counter containing a value over “1000.” After the mail transmission complete flag in the NV-RAM 202 is reset to “0” in a sequence S13-4, the toner supply retrial counter in the NV-RAM 202 is set to “3” in a sequence S13-5. Furthermore, the SCS 306 generates a call ID for identifying a particular toner supply call in an event A and stores the call ID in the NV-RAM 202 in a sequence S13-6. Each of the toner supply calls is an automatic report of the toner supply call information to notify a toner bottle order upon a toner near end. After the SCS 306 sets the supply call in-progress flag to “1” in NV-RAM 202 in a sequence S13-7, the SCS 306 transmits to the NRS 305 a toner supply call request in a sequence S13-8. In the above transmission, the device information for identifying the image forming apparatus 100 and the call ID stored in the NV-RAM 202 are added to the toner supply call request. In addition, the message, “toner supply call” is displayed on the character display on the operation panel 205.

Still referring to FIG. 13, the NRS 305, the intermediate apparatus 101 and the management apparatus 102 perform the following tasks. Upon receiving the toner supply call request, the NRS 305 generates a SOAP message for a toner supply call to notify the toner bottle order and transmits it to the intermediate apparatus 101 in a sequence S13-9. The SOAP message includes the device information and the call ID that have been added to the toner supply call request. Upon receiving the toner supply call SOAP message from the NRS 305, the intermediate apparatus 101 adds its own intermediate apparatus identifying information to the SOAP message and generates a HTTP message based upon the SOAP message. The intermediate apparatus 101 performs a toner supply call to the management apparatus 102 via the Internet 103 in a sequence S13-10. That is, the intermediate apparatus 101 automatically transmits the HTTP message including the toner supply call SOAP with the self intermediate apparatus identifier to the management device 102 at the service center via the Internet.

In case that the intermediate apparatus 101 fails to receive the HTTP message with a call OK SOAP message from the management apparatus 102 within a predetermined amount of time after the toner supply call is transmitted to the management apparatus 102 at the service center, the intermediate apparatus 101 generates a call NG SOAP message based upon the HTTP message and transmits it to the NRS 305 of the corresponding image forming apparatus 100 in a sequence S13-11. In response to the call NG SOAP message from the intermediate apparatus 101, the NRS 305 transmits the call NG indicative of the unsuccessfully completed toner supply call to the SCS 306 in a sequence S13-12. Upon receiving the call NG from the NRS 305, the SCS 306 determines that the toner supply call to the management apparatus 102 has failed and displays the “toner supply call failure” message on the display unit of the operation panel 205. Furthermore, the SCS 306 decrements the retrial counter by one in the in the NV-RAM 202 in a sequence S13-13. The SCS 306 performs the retry control in order to report again the HTTP message containing the identical toner supply call SOAP message of the initial try. That is, the SCS 306 checks the retrial counter value. If the retrial counter value is not “0,” the identical toner supply call has not reached a predetermined number of three retrials. The SCS 306 transmits to the NRS 305 the same toner supply call request that is identical to the initial call in a sequence S13-14 for the second time. In this regard, the same ID call that has been stored in the NV-RAM 202 for the initial call is added to the toner supply call request. The initial toner supply call is the initial HTTP message with the same toner supply call SOAP message.

Upon receiving the identical initial toner supply call from the SCS 306, the NRS 305 generates the identical initial toner supply call SOAP message and transmits it to the intermediate apparatus 101 in a sequence S13-15 for the second time. In response to the identical initial toner supply call SOAP message from the NRS 305, the intermediate apparatus 101 again adds its self intermediate device identifier to the SOAP message, generates a corresponding HTTP message based upon the above newly generated SOAP message and performs the toner supply call against the management apparatus 102 via the Internet 103 in a sequence S13-16. That is, the intermediate apparatus 101 automatically transmits the HTTP message with the toner supply call SOAP message including the self device identifier to the management apparatus 102 at the service center via the Internet 103 in the sequence S13-16. Subsequently, as a result of the toner supply call to the management apparatus 102 at the service center, in case that the intermediate apparatus 101 again for the second time fails to receive the HTTP message with a call OK SOAP message from the management apparatus 102 within a predetermined amount of time after a toner supply call is transmitted to the management apparatus 102 at the service center, the intermediate apparatus 101 again generates a call NG SOAP message based upon the HTTP message and transmits it to the NRS 305 of the corresponding image forming apparatus 100 in a sequence S13-17. In response to the call NG SOAP message from the intermediate apparatus 101, the NRS 305 again for the second time transmits the call NG indicative of the unsuccessfully completed toner supply call to the SCS 306 in a sequence S13-18. Upon receiving the call NG from the NRS 305, the SCS 306 determines that the toner supply call to the management apparatus 102 has failed again for the second time and decrements the retrial counter by one in the in the NV-RAM 202 in a sequence S13-19. Subsequently, the SCS 306 checks the retrial counter value. If the retrial counter value is not “0,” the SCS 306 transmits to the NRS 305 the same toner supply call request that is identical to the initial call in a sequence S13-20 for the third time.

Upon receiving the identical initial toner supply call from the SCS 306, the NRS 305 generates the identical initial toner supply call SOAP message and transmits it to the intermediate apparatus 101 in a sequence S13-21 for the third time. In response to the identical initial toner supply call SOAP message from the NRS 305, the intermediate apparatus 101 again adds its self intermediate device identifier to the SOAP message, generates a corresponding HTTP message based upon the above newly generated SOAP message and performs the toner supply call against the management apparatus 102 via the Internet 103 in a sequence S13-22. That is, the intermediate apparatus 101 automatically transmits the HTTP message with the toner supply call SOAP message including the self device identifier to the management apparatus 102 at the service center via the Internet 103 in the sequence S13-22. Subsequently, as a result of the toner supply call to the management apparatus 102 at the service center, in case that the intermediate apparatus 101 again for the third time fails to receive the HTTP message with a call OK SOAP message from the management apparatus 102 within a predetermined amount of time after a toner supply call is transmitted to the management apparatus 102 at the service center, the intermediate apparatus 101 again generates a call NG SOAP message based upon the HTTP message and transmits it to the NRS 305 of the corresponding image forming apparatus 100 in a sequence S13-23. In response to the call NG SOAP message from the intermediate apparatus 101, the NRS 305 again for the third time transmits the call NG indicative of the unsuccessfully completed toner supply call to the SCS 306 in a sequence S13-24. Upon receiving the call NG from the NRS 305, the SCS 306 determines that the toner supply call to the management apparatus 102 has failed again for the third time and decrements the retrial counter by one in the in the NV-RAM 202 in a sequence S13-25. Subsequently, the SCS 306 checks the retrial counter value. Since the retrial counter value has turned to “0” after the third trial for the identical toner supply call, the above described retrial sequences are terminated to perform the following sequences.

The additional sequences are related to the e-mail transmission. That is, the SCS 306 checks the mail transmission complete flag in the NV-RAM 202 in a sequence S13-27. If it is confirmed that the mail transmission complete flag value is “0,” the SCS 306 transmits to the DCS 316 an e-mail transmission request for indicating that a toner supply call to the management apparatus 102 has failed in a sequence S13-27. The e-mail transmission request includes the device number of the image forming apparatus 100 and the initial time call ID. After transmitting the above e-mail transmission request to the DCS 316, the SCS 306 sets the mail transmission complete flag to “1” in the NV-RAM 202 in a sequence S13-28 and activates the 24-hour timer in an event B. In response to the e-mail transmission request from the SCS 306, the DCS316 transmits to a supply management terminal or a personal computer e-mail indicating that a toner supply call to the management apparatus 102 has been failed via LAN. The above supply management terminal or personal computer is not shown in FIG. 13.

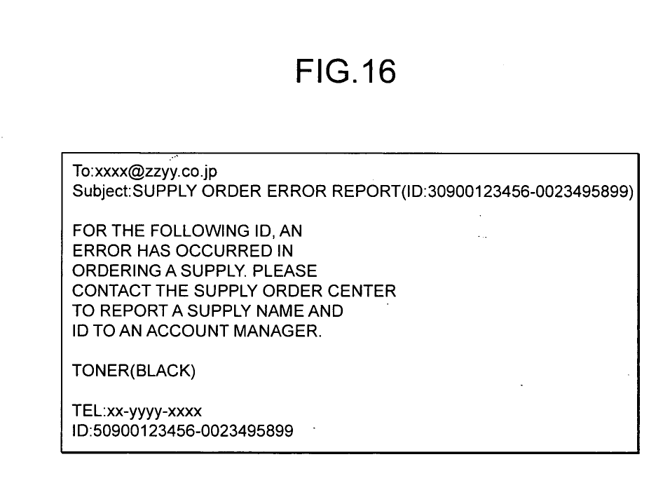

Now referring to FIG. 16, exemplary e-mail is illustrated to indicate that a toner supply call to the management apparatus 102 has been failed. The e-mail is transmitted to an e-mail address such as xxx@zz.yy.co.ip that has been initially specified during the system initialization of the image forming apparatus 100. In this example, the e-mail is addressed to the supply management terminal that is used by supply management personnel. Exemplary content of the e-mail includes a supply nomenclature such as “a black toner bottle” and the contact information such as the service center telephone number in addition to a pair of ID's such as the device ID of the image forming apparatus 100 and the identical initial call ID. The device ID is the first 11 digits while the call ID is the next 10 digits. In the first embodiment, since only a black toner bottle is used, simply a toner bottle suffices the supply nomenclature. On the other hand, a second preferred embodiment uses a plurality of toner bottles, a specific nomenclature such as a black toner bottle and a red toner bottle is necessary to indicate the toner bottle type in the e-mail. The supply management personnel using the supply management terminal that received the above e-mail makes a phone call to the indicated contact and communicates with the contact the supply nomenclature and the ID's.

At the service center, the following two tasks are performed to prevent a duplicate order. (1) After the telephonic contact from the device user has been made and the NRS communication returns normal, the HTTP message including the identical ID toner supply call SOAP message from the image forming apparatus 100 via the intermediate apparatus 100 is automatically reported to the management apparatus 102 at the service center via the Internet. If the HTTP message is normally received at the management apparatus 102, the toner supply call or the toner order call is ignored. The management apparatus registers the ID's that have been communicated via the telephonic contact. Thereafter, when the management apparatus 102 receives order call information containing the ID's that are identical to the registered ID's, the management apparatus 102 automatically abandons the received order call information as banned order information. The center operator initiates the toner supply ordering task via telephone. (2) After the identical order call information has been already reported, if a telephonic contact is made and the NRS communication returns normal before the telephonic contact, the center operator investigates whether or not a toner supply order has been made by the identical ID at the time of the telephone call. If he or she confirms that the order history exists for the ID's that are identical to the ones of the telephonic contact, since the ordering task has been already initiated via the NRS communication, no further ordering task is performed by telephone. The call ID has been reset to “0” at the installation time of the image forming apparatus 100.

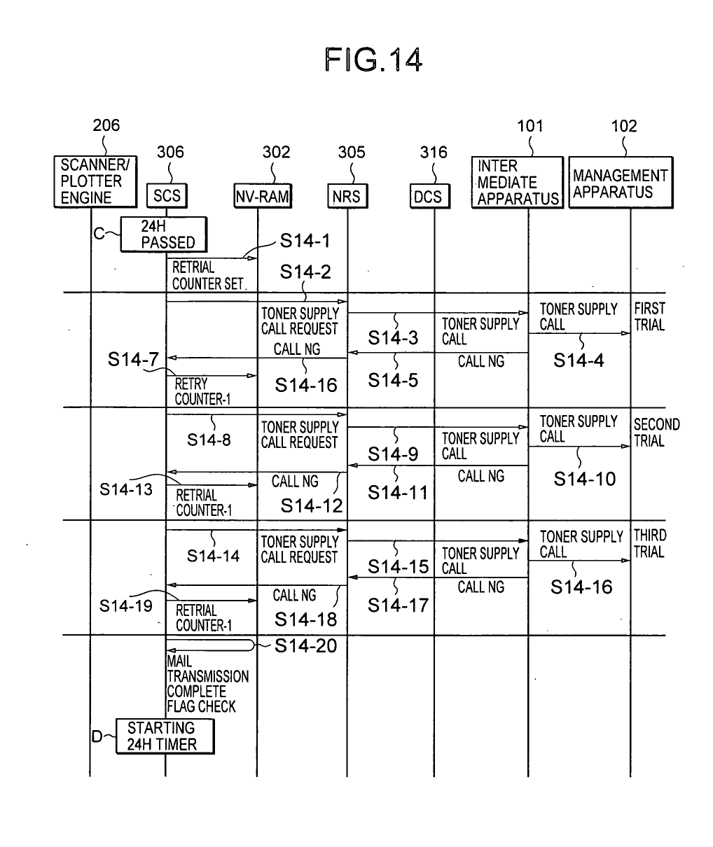

The SCS 306 of the controller board 100 in the image forming apparatus 100 with a toner near end event initiates the 24-Hour timer in the event B as shown in FIG. 13. Now referring to FIG. 14, a timing chart illustrates a communication sequence of events in a second preferred process of a failed toner supply call upon a toner near end event in the image forming device 100 in the remote management system according to the current invention after twenty-four hours have elapsed following the activation of the 24-Hour timer. At least twenty-four hours have passed in an event C, and the following tasks are performed. The SCS 306 resets the retrial counter value in the NV-RAM 202 to “3” in a sequence S14-1 to initiate the above described retrials as described with respect to FIG. 13. In order to report the HTTP message with the identical initial time toner supply call SOAP message, the tasks in sequences S14-2 through S14-7 have been performed for a first trial. Since the detail of the sequences S14-2 through S14-7 is substantially identical to the sequences S13-8 through S13-13 as described with respect to FIG. 13, the description of the sequences S14-2 through S14-7 is not reiterated here. Similarly, for the second retrial, since the detail of the sequences S14-8 through S14-13 is substantially identical to the sequences S13-14 through S13-19 as described with respect to FIG. 13, the description of the sequences S14-8 through S14-13 is not reiterated here. Lastly, for the third retrial, since the detail of the sequences S14-14 through S14-19 is substantially identical to the sequences S13-20 through S13-25 as described with respect to FIG. 13, the description of the sequences S14-14 through S14-19 is not reiterated here. Even after the above three trials, when the toner supply call to the management apparatus 102 has failed, the retrial is terminated. The SCS 306 checks the mail transmission complete flag in the NV-RAM 202. Since the mail transmission complete flag has been already set to “1,” the SCS 306 does not report to the DCS 316 an e-mail transmission request for indicating the toner supply call to the management apparatus 102 has failed. That is, the SCS 306 prohibits the transmission of the e-mail. Subsequently, the SCS 306 reactivates the 24-Hour timer in an event D. Until the toner supply call to the management apparatus 102 succeeds, the above described retrial sequences are repeated.

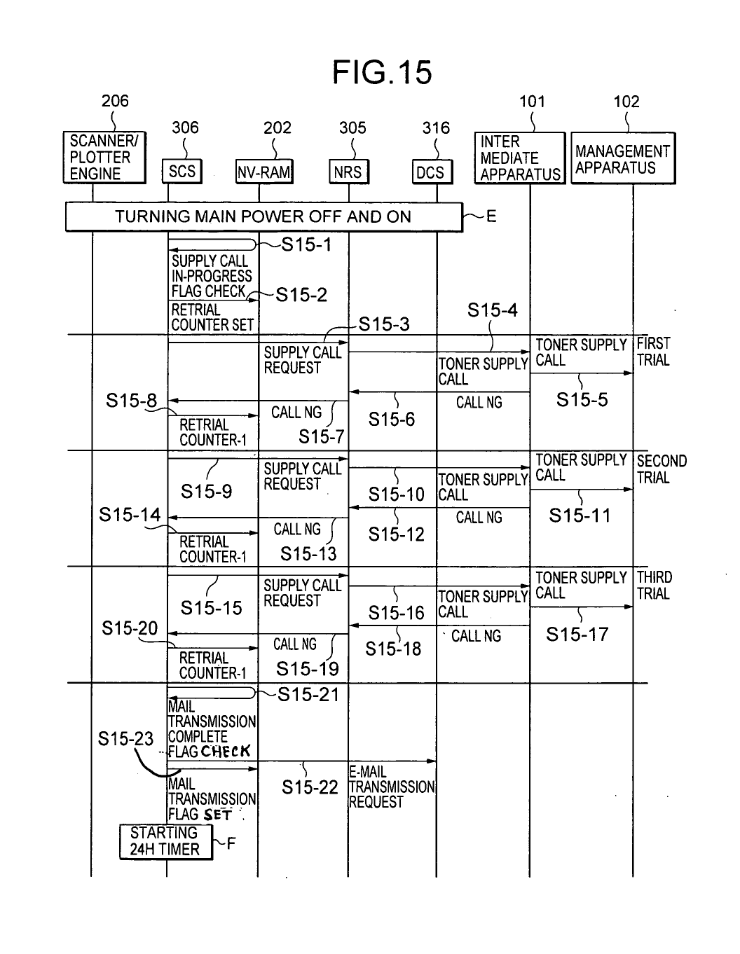

Now referring to FIG. 15, a timing chart illustrates a communication sequence of events in a third preferred process of a main power OFF/ON during a toner supply call upon a toner near end event in the image forming device 100 in the remote management system according to the current invention. While the toner supply call to the management apparatus 102 is being executed, if the main power or the power supply unit 207 is turned off and on, the following tasks are performed. In general, after the supply call in-progress flag value in the NV-RAM 202 is checked, if it is confirmed that the supply call in-progress flag value has been reset to “0,” no action is taken. On the other hand, if it is confirmed that the supply call in-progress flag value has been set to “1,” the flag value indicates that the main power has been turned off and on during the toner supply call to the management apparatus 102 and that the toner supply call has not been successfully processed. As a result of the flag indication, the above described retrial sequence will be executed. Even after the three trials, if the toner supply call to the management apparatus 102 is still unsuccessful, the retrial is terminated. Furthermore, the mail transmission complete flag value in the NV-RAM 202 is checked. Based upon the check result, the above described control is executed.

Still referring to FIG. 15, following the power supply interruption, the toner supply call is resumed in the following manner. As an event E occurs, the main power supply is shut off and later turned on. Following the power interruption event E, the SCS 306 checks the supply call in-progress flag value in the NV-RAM 202 in a sequence S15-1. If the SCS 306 confirms that the supply call in-progress flag value is “1,” the SCS 306 resets the retrial counter in the NV-RAM 202 to “3” in a sequence S15-2 prior to initiating the toner supply call. In order to report the HTTP message with the identical initial time toner supply call SOAP message, the tasks in sequences S15-3 through S15-8 have been performed for a first trial. Since the detail of the sequences S15-3 through S15-8 is substantially identical to the sequences S13-8 through S13-13 as described with respect to FIG. 13, the description of the sequences S15-3 through S15-8 is not reiterated here. Similarly, for the second retrial, since the detail of the sequences S15-9 through S15-14 is substantially identical to the sequences S13-14 through S13-19 as described with respect to FIG. 13, the description of the sequences S15-9 through S15-14 is not reiterated here. Lastly, for the third retrial, since the detail of the sequences S15-15 through S15-20 is substantially identical to the sequences S13-20 through S13-25 as described with respect to FIG. 13, the description of the sequences S15-15 through S15-20 is not reiterated here. Even after the above three trials, when the toner supply call to the management apparatus 102 has failed, the retrial is terminated. The SCS 306 checks the mail transmission complete flag value in the NV-RAM 202 in a sequence S15-21. Based upon the mail transmission complete flag value, the SCS 306 sends an e-mail transmission request to the DCS 316 in a sequence S15-22. Lastly, the SCS 306 sets the mail transmission complete flag in the NV-RAM 202 in a sequence S15-23 and initiates the 24-Hour timer in an event F.

On the other hand, if the management apparatus returns a call OK indicative of a successful toner supply handling after the sequence S15-5, S15-11 or S15-17, a series of sequences S12-11 through S12-19 will follow as described with respect to FIG. 12. No subsequent trial is resumed after the call OK is returned from the management apparatus 102. In this case, since the toner near end issue is successfully resolved, the 24-timer is not activated in the event F with respect to FIG. 15.

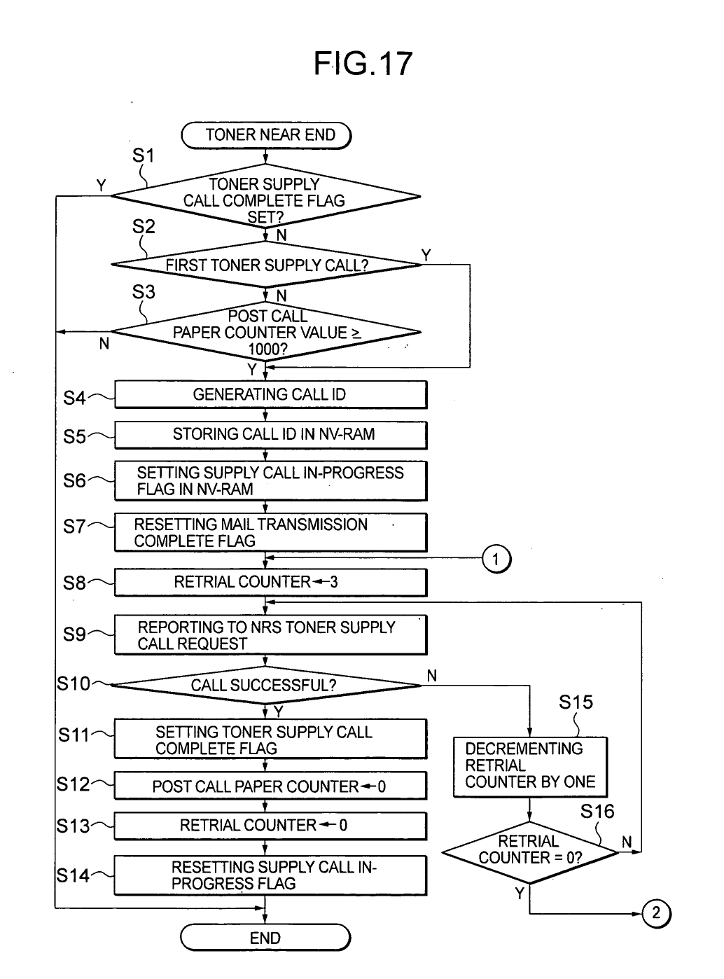

Now referring to FIG. 17, a flow chart illustrates steps involved in a preferred process of handling a toner supply call from an image forming apparatus to a management apparatus in the remote management system according to the current invention. In general, the SCS 306 on the controller board 200 in the image forming apparatus 100 handles the toner near end event. Upon receiving a toner near end notification from a detection unit after the toner near end occurs in the plotter engine, the SCS 306 of the image forming apparatus 100 initiates a process routine. In a step S1, the status of the toner supply call complete flag in the NV-RAM 202 is checked. If it is confirmed that the status has been reset to “0,” the preferred process proceeds to the step S2. It is then decided whether or not a toner supply call is performed for the first time after the installation/delivery of the image forming apparatus 100. If it is a first toner supply call or a first toner near end occurs, the preferred process proceeds to a step S4. On the other hand, it is determined in the step S2 that the toner supply call is not initial, it is further determined in a step S3 whether the post call paper counter in the NV-RAM 202 has reached the value of 1000. If the post call paper counter has reached “1000,” the preferred process proceeds to the step S4, where a call ID is generated. The call ID is generated for each time, and the call ID value differs from that of the previous time. For example, if the previously generated call ID has a value of “0000000001,” the currently generated call ID has a value of “0000000002.” During the retrials, the identical call ID is repeatedly used. If the toner supply call is not the first time and the post call paper counter has not reached “1000,” the preferred process terminates the supply call routine.

Still referring to FIG. 17, after the call ID has been generated in the step S4, the following steps are performed in the preferred process. In step S5, the generated ID is stored in the NV-RAM 202. In step S6, the supply call in-progress flag in the NV-RAM 202 is set to “1.” In a step S7, the mail transmission complete flag in the NV-RAM 202 is reset to “0.” After the retrial counter in the NV-RAM 202 is initialized to “3” in a step S8, the device number information of the image apparatus 100 and the call ID stored in the NV-RAM 202 are added to the toner supply call request in a step S9. The processed toner supply call request is transmitted to the NRS 305 in the step S9. Subsequently, in a step S10 it is determined whether or not a toner supply call has been successfully completed based upon the report from the NRS 305. If a call OK is received from the NRS 305 before the retrial counter reaches “0,” it is determined that the toner supply call to the management apparatus 102 was successful and the preferred process proceeds to a step S11 for performing the following steps. In the step S11, the toner supply call complete flag in the NV-RAM 202 is set to “1,” and in a step S12, the post call paper counter value is set to “0.” Subsequently, in a step S13, the retrial counter is reset to “0.” Lastly, the supply call in-progress flag in the NV-RAM 202 is reset to “0” in a step S14 before the preferred process terminates itself.

On the other hand, a call NG is received from the NRS 305 in the S10, it is determined that the toner supply call to the management apparatus 102 was unsuccessful and the preferred process proceeds to a step S15. After the retrial counter in the NV-RAM 202 has been decremented by one in the step S15, the retrial counter value is checked in a step S16. If the retrial counter value is not zero, the identical toner supply call has not repeated three times. In this case, the preferred process returns to the step S9, where the identical initial time toner supply call request is reported to the NRS 305. The identical initial time toner supply call request includes the device number of the image forming apparatus 100 and the identical initial time call ID that is stored in the NV-RAM 202. The above described steps S9, S10 and S15 are repeated until the retrial counter reaches “0.”

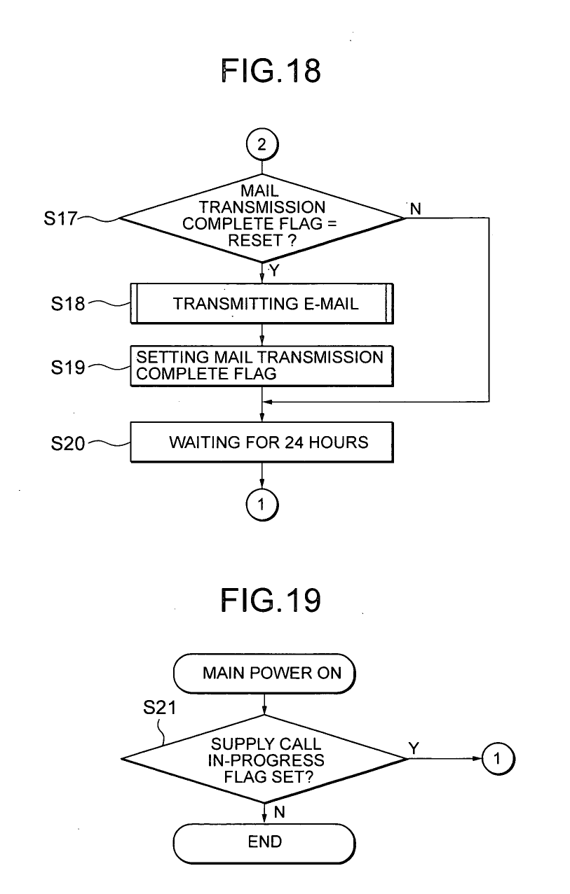

FIG. 18 is a flow chart illustrating steps involved in a part of the preferred process of handling a toner supply call from an image forming apparatus to a management apparatus in the remote management system according to the current invention. When the retrial counter reaches “0” as determined in the step S16, the preferred process performs the following steps S17 through S20. In a step S17, the mail transmission complete flag value in the NV-RAM 202 is checked. If it is confirmed that the mail transmission complete flag value is set to “1,” the preferred process proceeds to a step S20, where the 24-hour time is activated. On the other hand, it is confirmed that the mail transmission complete flag value is reset to “0,” an e-mail transmission request for indicating the failed toner supply call to the management apparatus 102 is transmitted to the DCS 316 in a step S118. The device number information of the image forming apparatus 100 and the identical initial time call ID are added to the e-mail transmission request. After the e-mail transmission request is reported to the DCS 316, the mail transmission complete flag in the NV-RAM 202 is set to “1” in a step S19. Subsequently, the 24-Hour time is activated in the step S20, and the preferred process returns to the step S8 of FIG. 17 after twenty-four hours have elapsed.

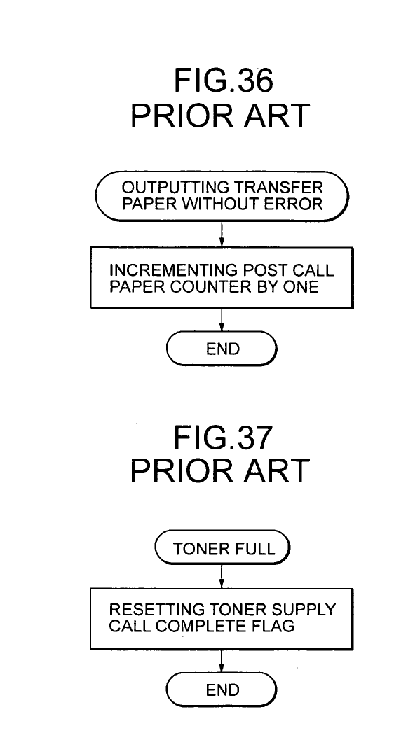

FIG. 19 is a flow chart illustrating steps involved in another part of the preferred process of handling a toner supply call from an image forming apparatus to a management apparatus in the remote management system according to the current invention. In general, the flow chart illustrates exemplary steps that are performed by the SCS 306 on the controller board 200 in the image forming apparatus 100 upon activating the main power source. The SCS 306 of the image forming apparatus 100 checks in a step S21 the supply call in-progress flag value in the NV-RAM 202 at the onset of the main power source. If it is confirmed in the step S21 that the supply call in-progress flag is set to “1,” the preferred process returns to the step S8 as illustrated in FIG. 17. On the other hand, it is confirmed in the step S21 that the supply call in-progress flag is set to “0,” the preferred process terminates itself. Furthermore, since the steps by the SCS 306 for handling of the transfer paper normal output and the toner full are respectively equivalent to those described in FIGS. 36 and 37, the description and the figures are not reiterated.

With respect to the first preferred embodiment, the following ten advantages are gained. (1) When the image forming apparatus 100 or 110 detects its own toner near end condition, the toner supply call information for notifying a toner bottle order is sent to the management apparatus 102. By setting the supply call in-progress flag to “1,” even if the transmission of the toner supply call information is interrupted by turning off the main power source, the in-progress transmission of the toner supply call information is resumed by referring to the status of the supply call in-progress flag after the main power is again turned on.

(2) When the image forming apparatus 100 transmits a toner supply call to the management apparatus 102, a call ID is generated to identify the transmission. By adding the call ID to the toner supply call information, since the duplicate transmission from the image forming apparatus 100 for the identical toner supply call information is recognized at the management apparatus 102, the duplicate ordering of the toner bottle is prevented.

(3) When the image forming apparatus 100 receives from the management apparatus 102 a transmission result indicative of a normal reception of the toner supply call, it is determined that the transmission of the toner supply call information is successful. By resetting the supply call in-progress flag to “0,” it is subsequently confirmed that the transmission of the toner supply call information is completed by referring to the status of the SC call complete flag.

(4) When the image forming apparatus 100 fails to receive from the management apparatus 102 a transmission result indicative of a normal reception of the toner supply call, it is determined that the transmission of the toner supply call information is unsuccessful. In the event of the failed transmission, if the number of transmission of the identical toner supply call information has not reached a predetermined number, the toner supply call information is transmitted to the management apparatus 102. If the number of transmission of the identical toner supply call information has reached a predetermined number, the retrial of the toner supply call is terminated. By the above transmission controls, even if a communication trouble occurs during the toner supply call transmission, the transmission of the toner supply call information is completed.

(5) Since the image forming apparatus 100 repeatedly adds the identical initial time call ID to the toner supply call information during the transmission retrials, the image forming apparatus 100 does not have to generate a different call ID for transmitting the identical toner supply call information. As a result, the processing efficiency increases.

(6) After the image forming apparatus 100 stops the re-transmission of the toner supply call information, by reporting to a supply management terminal via e-mail that the toner supply call to the management apparatus has failed, the supply management personnel of the supply management terminal refers to the reported content so that he or she can communicate with a center operator about the toner bottle order in the toner supply cal information. In lieu of reporting to the supply management terminal, the same information is displayed on the operation panel 205 or printed on paper. That is, the content of the toner supply call information is assuredly communicated to the center operator.

(7) After the failed toner supply call transmission to the management apparatus 102 is reported via e-mail, the image forming apparatus 100 sets the mail flag transmission complete flag indicative of the complete e-mail transmission to “1” to prohibit the same report so that the duplicate report is avoided. The above mechanism improves the processing efficiency.

(8) After the mail flag transmission complete flag has been set to “1,” if a toner near end situation is detected, the mail flag transmission complete flag is now reset to “0” to release the prohibition of the e-mail transmission. As a result of the reset flag, the e-mail transmission for the failed toner supply call to the management apparatus 102 is again enabled. By the above mechanism, the content of the toner supply call is assuredly reported to the center operator.

(9) After the image forming apparatus 100 activates the 24-hour timer and 24 hours have elapsed by the measurement of the 24-hour timer, by performing the retransmission as described above, the content of the toner supply call is furthermore assuredly reported to the center operator. Alternatively, in lieu of the 24-hour timer, any timer that measures a predetermined amount of time is used in the above system.

(10) When a main power source is turned ON, the image forming apparatus 100 evaluates the toner supply call in-progress flag. If the image forming apparatus 100 confirms that the toner supply call in-progress flag has been set to “1,” it determines that the toner supply call to the management apparatus 102 has failed and performs the above described retransmission. Even if its own main power supply source is turned to interrupt the transmission of the toner supply call to the management apparatus 102, the image forming apparatus 100 automatically resumes the interrupted transmission of the toner supply call information when the power supply source is turned on. As a result, the content of the toner supply call is expediently and assuredly reported to the center operator. Furthermore, upon the power on, if the image forming apparatus 100 confirms that the toner supply call in-progress flag has been set to “1,” it determines that the toner supply call to the management apparatus 102 has failed and performs the above described retransmission. The failed transmission is reported by displaying on a display unit on the operation panel 205 or is printing on paper. If the above reporting is done, the in-progress toner supply call is resumed, for example, by the operation on the operation panel 205.

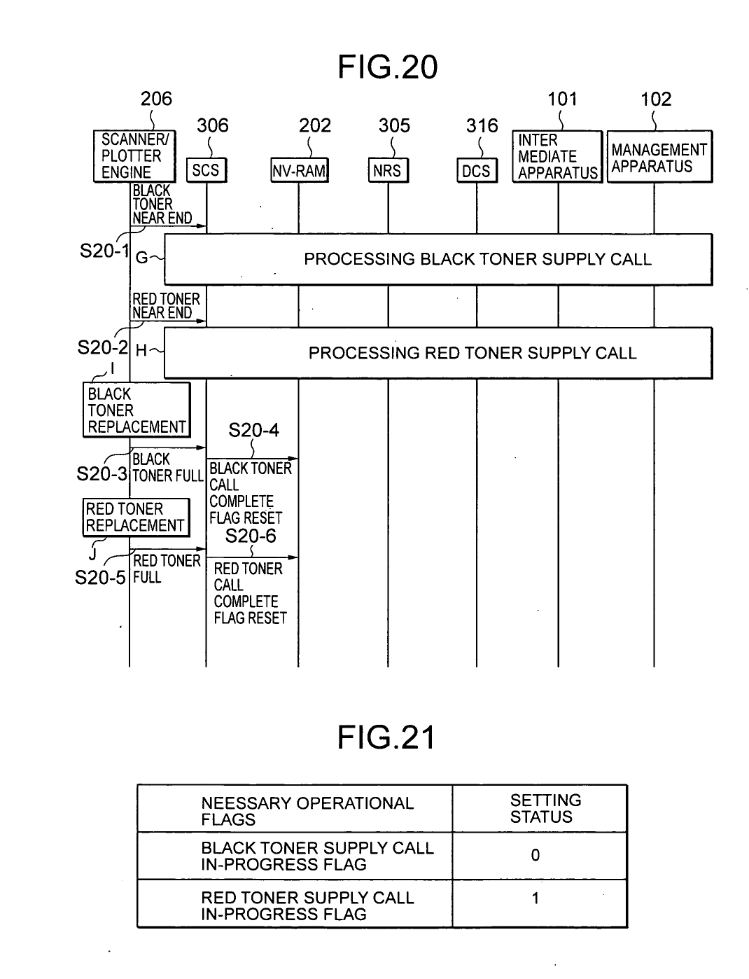

Now referring to FIG. 20, a timing chart illustrates a communication sequence of events in a third preferred process of a toner supply call upon a toner near end event in the image forming device 100 in the remote management system according to the current invention. In general, the third preferred process includes two separate processes for processing a black toner supply call in a process G and a red toner supply call in a process H. Each of the processes G and H is substantially identical to the first preferred process but specific to either black toner or red toner. In the process G, when a toner near end event of a black toner bottle occurs in the plotter engine, a toner level goes below a predetermined level in the black toner bottle. The corresponding detector detects the above black toner near end event and reports the detection result to the SCS 306 on the controller board 200 in a sequence S20-1. In the following sequences, no specific reference is made to a particular sequence reference number, but the sequences are substantially identical to those as previously described with respect to FIGS. 12, 13, 14 and 15. Upon receiving the black toner near end detection result from the plotter engine, the SCS 306 determines that the toner near end occurred in the plotter engine and that the type of the toner near end is a black toner near end. The SCS 306 checks the value of the black toner supply call complete flag and the black post call paper counter in the non-volatile random access memory (NV-RAM) 202. If the black toner supply call complete flag has been reset to “0” and the black post call paper counter contains a value over “1000,” the SCS 306 determines that the black toner supply call issuance condition has been satisfied.

On the other hand, if the black toner supply call complete flag has not been reset to “0” or no black toner supply call has been made, the above condition is ignored even with the black post call paper counter containing a value over “1000.” After a black toner mail transmission complete flag in the NV-RAM 202 is reset to “0,” the toner supply retrial counter in the NV-RAM 202 is set to “3.” Furthermore, the SCS 306 generates a call ID for identifying a particular toner supply call and stores the call ID in the NV-RAM 202. Each of the black toner supply calls is an automatic report of the toner supply call information to notify a black toner bottle order upon a black toner near end. After the SCS 306 sets the black toner supply call in-progress flag to “1” in NV-RAM 202, the SCS 306 transmits to the NRS 305 a black toner supply call request. In the above transmission, the device information for identifying the image forming apparatus 100 and the call ID stored in the NV-RAM 202 as well as a toner near end type are added to the black toner supply call request. The above toner near end type is a corresponding toner supply call, and in this case, it is a black toner supply call. In addition, the message, “black toner supply call in progress” is displayed on the character display on the operation panel 205.

Still referring to FIG. 20, the NRS 305, the intermediate apparatus 101 and the management apparatus 102 perform the following tasks. Upon receiving the toner supply call request, the NRS 305 generates a SOAP message for the black toner supply call to notify the black toner bottle order and transmits it to the intermediate apparatus 101. The SOAP message includes the device information and the call ID that have been added to the black toner supply call request. Upon receiving the black toner supply call SOAP message from the NRS 305, the intermediate apparatus 101 adds its own intermediate apparatus identifying information to the SOAP message and generates a HTTP message based upon the SOAP message. The intermediate apparatus 101 performs a black toner supply call to the management apparatus 102 via the Internet 103. That is, the intermediate apparatus 101 automatically transmits the HTTP message including the black toner supply call SOAP with the self intermediate apparatus identifier to the management device 102 at the service center via the Internet. Upon successfully receiving the HTTP message with the black toner supply call SOAP message from the intermediate apparatus 101 at the user side, the management apparatus 102 generates a call OK SOAP message indicative of a successful reception of the HTTP message based upon the device information and the intermediate identifier that has been added to the SOAP message in the received HTTP message.

The successful call OK SOAP message means that the black toner supply call process has successfully processed. The management apparatus 102 then transmits the above generated black toner SOAP message to the original intermediate apparatus 101 via the Internet 103. The original intermediate apparatus 101 is the one that had transmitted the HTTP message with the black toner supply call SOAP message. The SOAP message or the black toner supply call information from the received HTTP message is stored in a queue in the database 605. The stored information waits in the queue for the center operator to process the black toner bottle order. The SOAP message content in the received HTTP message is further displayed at the display unit of the operator terminal 604 in order to notify the operator. Following the black toner near end in the plotter engine of the image forming apparatus 100 that is connected to the reporting source of the intermediate apparatus 101, when the center operator confirms that a black toner bottle has been requested by the display content on the display unit at the operator terminal 604, he or she orders the black toner bottle. For example, a repair person is arranged to deliver a black toner bottle to an installation location of the reporting source intermediate apparatus 101.

Upon receiving the HTTP message with the call OK SOAP message from the management apparatus 102 as a result of the black toner supply call to the management apparatus 102, the intermediate apparatus 101 generates a call OK SOAP message based upon the HTTP message and transmits it to the NRS 305 of the image forming apparatus 100 with the black toner near end event. After receiving the call OK SOAP message from the intermediate apparatus 101, the NRS 305 reports to the SCS 306 the call OK indicative of the successfully completed black toner supply call. In response to the call OK from the NRS 305, the SCS 306 determines that the black toner supply call to the management apparatus 102 has been successfully completed, and the SCS 306 displays the “black toner supply call successful” message on the display unit of the operation panel 205. Subsequently, the SCS 306 resets the supply call in-progress flag to “0” in the NV-RAM 202 while the SCS 306 also sets the toner supply call complete flag to “1” in the NV-RAM 202. Furthermore, the SCS 306 resets the post call paper counter value and the retrial counter value to “0” in the NV-RAM 202 so the two counters operates from “0.”

After the black toner bottle is replaced in a plotter engine of the image forming apparatus 100 in an event I, a black toner full event occurs in a sequence S20-3. That is, the amount of black toner is full in the black toner bottle. The corresponding detector detects the black toner full and reports it to the SCS 306. Upon receiving the black toner full signal from the plotter engine, the SCS 306 resets the black supply call complete flag to “0” in the NV-RAM 202 in a sequence S20-4 in order to perform a next black supply call for a subsequent black toner near end. However, a subsequent black toner supply call is not performed unless the black post call paper counter value reaches 1000.

Still referring to FIG. 20, the black toner supply call process G in the timing chart also includes the following communication events in case of a failed toner supply call following a toner near end event in the image forming device 100 in the remote management system according to the current invention. If the intermediate apparatus 101 fails to receive the HTTP message with a call OK SOAP message from the management apparatus 102 within a predetermined amount of time after the black toner supply call is transmitted to the management apparatus 102 at the service center, the intermediate apparatus 101 generates a call NG SOAP message based upon the HTTP message and transmits it to the NRS 305 of the corresponding image forming apparatus 100. In response to the call NG SOAP message from the intermediate apparatus 101, the NRS 305 transmits the call NG indicative of the unsuccessfully completed black toner supply call to the SCS 306. Upon receiving the call NG from the NRS 305, the SCS 306 determines that the black toner supply call to the management apparatus 102 has failed and displays the “black toner supply call failure” message on the display unit of the operation panel 205. Furthermore, the SCS 306 decrements the retrial counter by one in the in the NV-RAM 202. The SCS 306 performs the retry control in order to report again the HTTP message containing the identical black toner supply call SOAP message of the initial try. That is, the SCS 306 checks the retrial counter value. If the retrial counter value is not “0,” the identical black toner supply call has not reached a predetermined number of three retrials. The SCS 306 transmits to the NRS 305 the same black toner supply call request that is identical to the initial call for the second time. In this regard, the same ID call that has been stored in the NV-RAM 202 for the initial call is added to the black toner supply call request. The initial black toner supply call is the initial HTTP message with the same black toner supply call SOAP message.

Upon receiving the identical initial black toner supply call from the SCS 306, the NRS 305 generates the identical initial black toner supply call SOAP message and transmits it to the intermediate apparatus 101 for the second time. In response to the identical initial black toner supply call SOAP message from the NRS 305, the intermediate apparatus 101 again adds its self intermediate device identifier to the SOAP message, generates a corresponding HTTP message based upon the above newly generated SOAP message and performs the black toner supply call against the management apparatus 102 via the Internet 103. That is, the intermediate apparatus 101 automatically transmits the HTTP message with the black toner supply call SOAP message including the self device identifier to the management apparatus 102 at the service center via the Internet 103. Subsequently, as a result of the black toner supply call to the management apparatus 102 at the service center, in case that the intermediate apparatus 101 again for the second time fails to receive the HTTP message with a call OK SOAP message from the management apparatus 102 within a predetermined amount of time after the black toner supply call is transmitted to the management apparatus 102 at the service center, the intermediate apparatus 101 again generates a call NG SOAP message based upon the HTTP message and transmits it to the NRS 305 of the corresponding image forming apparatus 100. In response to the call NG SOAP message from the intermediate apparatus 101, the NRS 305 again for the second time transmits the call NG indicative of the unsuccessfully completed black toner supply call to the SCS 306. Upon receiving the call NG from the NRS 305, the SCS 306 determines that the black toner supply call to the management apparatus 102 has failed again for the second time and decrements the retrial counter by one in the in the NV-RAM 202. Subsequently, the SCS 306 checks the retrial counter value. If the retrial counter value is not “0,” the SCS 306 transmits to the NRS 305 the same black toner supply call request that is identical to the initial call for the third time.

Upon receiving the identical initial toner supply call from the SCS 306, the NRS 305 generates the identical initial black toner supply call SOAP message and transmits it to the intermediate apparatus 101 for the third time. In response to the identical initial black toner supply call SOAP message from the NRS 305, the intermediate apparatus 101 again adds its self intermediate device identifier to the SOAP message, generates a corresponding HTTP message based upon the above newly generated SOAP message and performs the black toner supply call against the management apparatus 102 via the Internet 103. That is, the intermediate apparatus 101 automatically transmits the HTTP message with the black toner supply call SOAP message including the self device identifier to the management apparatus 102 at the service center via the Internet 103. Subsequently, as a result of the black toner supply call to the management apparatus 102 at the service center, in case that the intermediate apparatus 101 again for the third time fails to receive the HTTP message with a call OK SOAP message from the management apparatus 102 within a predetermined amount of time after the black toner supply call is transmitted to the management apparatus 102 at the service center, the intermediate apparatus 101 again generates a call NG SOAP message based upon the HTTP message and transmits it to the NRS 305 of the corresponding image forming apparatus 100. In response to the call NG SOAP message from the intermediate apparatus 101, the NRS 305 again for the third time transmits the call NG indicative of the unsuccessfully completed black toner supply call to the SCS 306. Upon receiving the call NG from the NRS 305, the SCS 306 determines that the black toner supply call to the management apparatus 102 has failed again for the third time and decrements the retrial counter by one in the in the NV-RAM 202. Subsequently, the SCS 306 checks the retrial counter value. Since the retrial counter value has turned to “0” after the third trial for the identical black toner supply call, the above described retrial sequences are terminated to perform the following sequences.

The additional sequences are related to the e-mail transmission. That is, the SCS 306 checks the black toner mail transmission complete flag in the NV-RAM 202. If it is confirmed that the black toner mail transmission complete flag value is “0,” the SCS 306 transmits to the DCS 316 an e-mail transmission request for indicating that a black toner supply call to the management apparatus 102 has failed. The e-mail transmission request includes the device number of the image forming apparatus 100 and the initial time call ID. After transmitting the above e-mail transmission request to the DCS 316, the SCS 306 sets the black toner mail transmission complete flag to “1” in the NV-RAM 202 and activates the 24-hour timer. In response to the e-mail transmission request from the SCS 306, the DCS316 transmits to a supply management terminal or a personal computer e-mail indicating that the black toner supply call to the management apparatus 102 has been failed via LAN. The above supply management terminal or personal computer is not shown in FIG. 20.

After the SCS 306 of the controller board 100 in the image forming apparatus 100 with a black toner near end event initiates the 24-Hour timer and twenty-four hours have elapsed, a communication sequence of events in a second preferred process of a failed black toner supply call upon a black toner near end event in the image forming device 100 in the remote management system according to the current. The SCS 306 resets the retrial counter value in the NV-RAM 202 to “3” to initiate the above described retrials as described with respect to FIG. 13. In order to report the HTTP message with the identical initial time black toner supply call SOAP message, a set of the tasks will be performed. Since the detail of the current sequences for these tasks for the first trial is substantially identical to the sequences S13-8 through S13-13 as described with respect to FIG. 13, the description of the current sequences is not reiterated here. Similarly, for the second retrial, since the detail of the current sequences for the second set of tasks is substantially identical to the sequences S13-14 through S13-19 as described with respect to FIG. 13, the description of the current sequences is not reiterated here. Lastly, for the third retrial, since the detail of the current sequences of the third set of tasks is substantially identical to the sequences S13-20 through S13-25 as described with respect to FIG. 13, the description of the current sequences S14-14 through S14-19 is not reiterated here. Even after the above three trials, when the black toner supply call to the management apparatus 102 has failed, the retrial is terminated. The SCS 306 checks the black toner mail transmission complete flag in the NV-RAM 202. Since the black toner mail transmission complete flag has been already set to “1,” the SCS 306 does not report to the DCS 316 an e-mail transmission request for indicating the black toner supply call to the management apparatus 102 has failed. That is, the SCS 306 prohibits the transmission of the e-mail. Subsequently, the SCS 306 reactivates the 24-hour timer. Until the black toner supply call to the management apparatus 102 succeeds, the above described retrial sequences are repeated.

Still referring to FIG. 20, the black toner supply call process G in the timing chart also includes the third preferred process of the following communication events in case of a main power OFF/ON during a black toner supply call upon a toner near end event in the image forming device 100 in the remote management system according to the current invention. While the black toner supply call to the management apparatus 102 is being executed, if the main power or the power supply unit 207 is turned off and on, the following tasks are performed. In general, after the black toner supply call in-progress flag value in the NV-RAM 202 is checked, if it is confirmed that the black toner supply call in-progress flag value has been reset to “0,” no action is taken. On the other hand, if it is confirmed that the black toner supply call in-progress flag value has been set to “1,” the flag value indicates that the main power has been turned off and on during the black toner supply call to the management apparatus 102 and that the black toner supply call has not been successfully processed. As a result of the flag indication, the above described retrial sequence will be executed. Even after the three trials, if the black toner supply call to the management apparatus 102 is still unsuccessful, the retrial is terminated. Furthermore, the black toner mail transmission complete flag value in the NV-RAM 202 is checked. Based upon the check result, the above described control is executed.

Still referring to FIG. 20, following the power supply interruption, the toner supply call is resumed in the following manner. After the main power supply is shut off and later turned on, the SCS 306 checks the black toner supply call in-progress flag value in the NV-RAM 202. If the SCS 306 confirms that the black toner supply call in-progress flag value is “1,” the SCS 306 resets the retrial counter in the NV-RAM 202 to “3” prior to initiating the toner supply call. In order to report the HTTP message with the identical initial time black toner supply call SOAP message, a set of the tasks will be performed for a first trial. Since the detail of the current sequences is substantially identical to the sequences S13-8 through S13-13 as described with respect to FIG. 13, the description of the current sequences is not reiterated here. Similarly, for the second retrial, since the detail of the current sequences is substantially identical to the sequences S13-14 through S13-19 as described with respect to FIG. 13, the description of the current sequences is not reiterated here. Lastly, for the third retrial, since the detail of the current sequences is substantially identical to the sequences S13-20 through S13-25 as described with respect to FIG. 13, the description of the current sequences is not reiterated here. Even after the above three trials, when the black toner supply call to the management apparatus 102 has failed, the retrial is terminated. The SCS 306 checks the black toner mail transmission complete flag value in the NV-RAM 202. Based upon the black toner mail transmission complete flag value, the SCS 306 sends an e-mail transmission request to the DCS 316. Lastly, the SCS 306 sets the black toner mail transmission complete flag in the NV-RAM 202 and initiates the 24-Hour timer.

Still referring to FIG. 20, after the black toner bottle supply call process G as described above, but before the black toner bottle replacement event I, it is assumed that a red toner near end event has occurred in a sequence S20-2. That is, the red toner amount in the red toner bottle in the plotter engine of the image forming apparatus 100 goes below a predetermined level. The corresponding detector in the plotter engine detects the red toner near end event and reports it to the controller board 200 of the SCS 306. Upon receiving the red toner near end report from the plotter engine, the SCS 306 determines that a toner near end has occurred in the plotter engine and that the toner near end is a red toner near end. In response to the red toner near end event, the red toner supply call process H is now activated so that the image forming apparatus 100, the intermediate apparatus 101 and the management apparatus 102 perform the tasks that are substantially similar to those described above with respect to the black toner supply call process G. Because of the substantial similarity, the detail of the tasks in the red toner supply call process G is not reiterated here. Following the red toner supply call process H, if the red toner supply call result is successful, a red toner bottle is replaced in a red toner replacement event J. After the red toner bottle is replaced in a plotter engine of the image forming apparatus 100 in an event J, a red toner full event occurs in a sequence S20-5. That is, the amount of red toner is full in the red toner bottle. The corresponding detector detects the red toner full and reports it to the SCS 306. Upon receiving the red toner full signal from the plotter engine, the SCS 306 resets the red supply call complete flag to “0” in the NV-RAM 202 in a sequence S20-6 in order to perform a next red supply call for a subsequent red toner near end. However, a subsequent red toner supply call is not performed unless the red post call paper counter value reaches 1000.

Lastly, still referring to FIG. 20, although the above described black and red toner supply call processes G and H are described separately and sequentially, the two processes G and H may be independent and concurrently performed according to the current invention. For example, the system according to the current invention is implemented to have the independent detection of the black and red toner near end events. Following the independent toner near end detection, the red and black toner supply call processes G and H are also independently executed. As the result of the independent execution of the red and black toner supply call processes G and H at a substantially identical time, if both black and red toner bottles are physically available for replacement at the image forming apparatus 100, it is efficient to replace the two toner bottles at the same time during a single repair service. On the other hand, after the execution of the black and red supply call processes, if either of the black or red toner bottles is not available, the system according to the current invention allows to make a different arrangement for delivering the toner bottles depending upon a predetermined set of criteria or a device user input. For example, if only a black toner bottle is available following the black and red toner supply call processes G and H, the service call may be delayed until the red toner bottle is later available. Alternatively, the service call is immediately made to replace the black toner bottle, and another service call will be later made upon the availability of the red toner bottle.

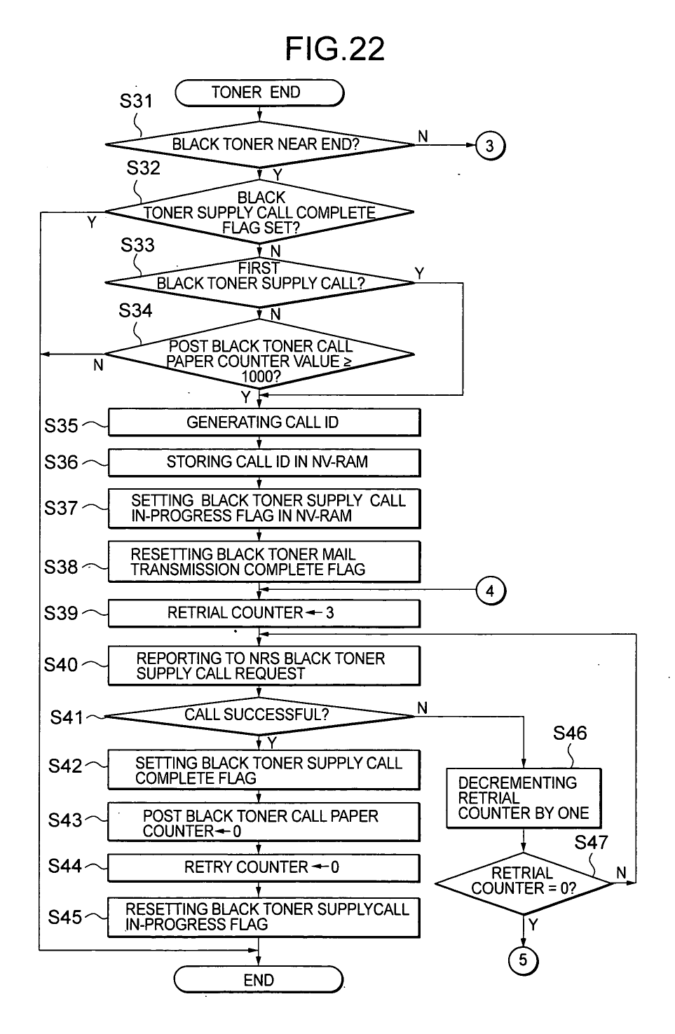

Now referring to FIGS. 22 through 25, flow charts illustrate steps involved in the preferred third process of handling the black and red toner supply call from the image forming apparatus to the management apparatus in the remote system according to the current invention. In general, FIGS. 22 through 25 illustrate that the SCS 306 on the controller board 200 in the image forming apparatus 100 handles the toner near end events. Referring particular to FIG. 22, a flow chart illustrate steps involved in a preferred process of handling the black supply call from the image forming apparatus to the management apparatus in the remote system according to the current invention. Upon receiving a black or red toner near end notification from a detection unit after the toner near end occurs in the plotter engine, the SCS 306 of the image forming apparatus 100 initiates a process routine. In a step S31, it is determined whether the toner near end is a black toner near end event. If the SCS 306 determines that the toner near end is a black toner near end in the step S31, the preferred process proceeds to a step S32, where the status of the black toner supply call complete flag in the NV-RAM 202 is checked. If it is confirmed that the status has been reset to “0,” the preferred process proceeds to the step S33. It is then decided whether or not the black toner supply call is performed for the first time after the installation/delivery of the image forming apparatus 100. If it is a first black toner supply call or a first black toner near end occurs, the preferred process proceeds to a step S35. On the other hand, it is determined in the step S33 that the black toner supply call is not initial, it is further determined in a step S34 whether the black toner post call paper counter in the NV-RAM 202 has reached the value of 1000. If the black toner post call paper counter has reached “1000,” the preferred process proceeds to the step S35, where a call ID is generated. If the toner supply call is not the first time and the post call paper counter has not reached “1000,” the preferred process terminates the supply call routine.

Still referring to FIG. 22, after the call ID has been generated in the step S35, the following steps are performed in the preferred process. In step S36, the generated ID is stored in the NV-RAM 202. In step S37, the black toner supply call in-progress flag in the NV-RAM 202 is set to “1.” In a step S38, the black toner mail transmission complete flag in the NV-RAM 202 is reset to “0.” After the retrial counter in the NV-RAM 202 is initialized to “3” in a step S39, the device number information of the image apparatus 100 and the call ID stored in the NV-RAM 202 are added to the black toner supply call request in a step S40. The processed black toner supply call request is transmitted to the NRS 305 in the step S40. Subsequently, in a step S41 it is determined whether or not the black toner supply call has been successfully completed based upon the report from the NRS 305. If a call OK is received from the NRS 305 before the retrial counter reaches “0,” it is determined that the black toner supply call to the management apparatus 102 was successful and the preferred process proceeds to a step S42 for performing the following steps. In the step S42, the black toner supply call complete flag in the NV-RAM 202 is set to “1,” and in a step S43, the black toner post call paper counter value is set to “0.” Subsequently, in a step S44, the retrial counter is reset to “0.” Lastly, the black supply call in-progress flag in the NV-RAM 202 is reset to “0” in a step S45 before the preferred process terminates itself.

On the other hand, a call NG is received from the NRS 305 in the S41, it is determined that the toner supply call to the management apparatus 102 was unsuccessful and the preferred process proceeds to a step S46. After the retrial counter in the NV-RAM 202 has been decremented by one in the step S46, the retrial counter value is checked in a step S47. If the retrial counter value is not zero, the identical black toner supply call has not repeated three times. In this case, the preferred process returns to the step S40, where the identical initial time black toner supply call request is reported to the NRS 305. The identical initial time black toner supply call request includes the device number of the image forming apparatus 100 and the identical initial time call ID that is stored in the NV-RAM 202. The above described steps S40, S41 and S46 are repeated until the retrial counter reaches “0.”

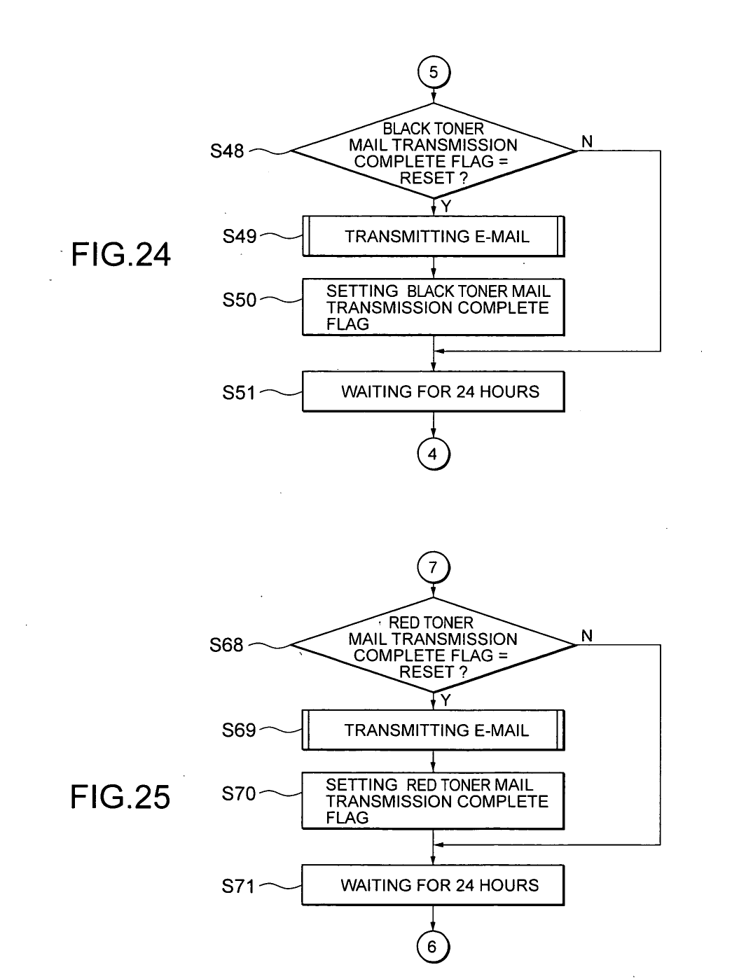

FIG. 24 is a flow chart illustrating steps involved in a part of the preferred process of handling the above black toner supply call from an image forming apparatus to a management apparatus in the remote management system according to the current invention. When the retrial counter reaches “0” as determined in the step S47 in FIG. 22, the preferred process performs the following steps S48 through S51. In a step S48, the black tone mail transmission complete flag value in the NV-RAM 202 is checked. If it is confirmed that the black toner mail transmission complete flag value is set to “1,” the preferred process proceeds to a step S51, where the 24-hour time is activated. On the other hand, it is confirmed that the black toner mail transmission complete flag value is reset to “0,” an e-mail transmission request for indicating the failed black toner supply call to the management apparatus 102 is transmitted to the DCS 316 in a step S49. The device number information of the image forming apparatus 100 and the identical initial time call ID are added to the e-mail transmission request. After the e-mail transmission request is reported to the DCS 316, the black toner mail transmission complete flag in the NV-RAM 202 is set to “1” in a step S50. Subsequently, the 24-Hour time is activated in the step S51, and the preferred process returns to the step S38 of FIG. 22 after twenty-four hours have elapsed.

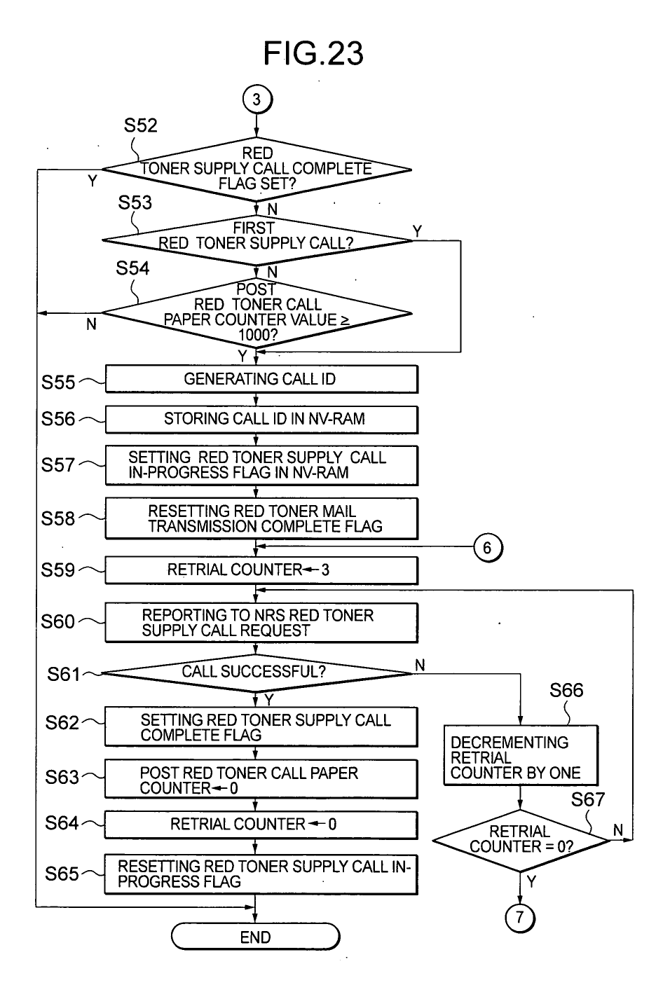

Still referring to FIG. 22, in the step S31, it is determined whether the toner near end is a black toner near end event. If the SCS 306 determines that the toner near end is a red toner near end in the step S31, the preferred process proceeds to a step S52 of FIG. 23. Referring now to FIG. 23, a flow chart illustrate steps involved in a preferred process of handling the red supply call from the image forming apparatus to the management apparatus in the remote system according to the current invention. In the step S52, the status of the red toner supply call complete flag in the NV-RAM 202 is checked. If it is confirmed that the status has been reset to “0,” the preferred process proceeds to a step S53. It is then decided whether or not the red toner supply call is performed for the first time after the installation/delivery of the image forming apparatus 100. If it is a first red toner supply call or a first red toner near end occurs, the preferred process proceeds to a step S55. On the other hand, it is determined in the step S53 that the red toner supply call is not initial, it is further determined in a step S54 whether the red toner post call paper counter in the NV-RAM 202 has reached the value of 1000. If the red toner post call paper counter has reached “1000,” the preferred process proceeds to the step S55, where a call ID is generated. If the toner supply call is not the first time and the post call paper counter has not reached “1000,” the preferred process terminates the supply call routine.

Still referring to FIG. 23, after the call ID has been generated in the step S55, the following steps are performed in the preferred process. In step S56, the generated ID is stored in the NV-RAM 202. In step S57, the red toner supply call in-progress flag in the NV-RAM 202 is set to “1.” In a step S58, the red toner mail transmission complete flag in the NV-RAM 202 is reset to “0.” After the retrial counter in the NV-RAM 202 is initialized to “3” in a step S59, the device number information of the image apparatus 100 and the call ID stored in the NV-RAM 202 are added to the red toner supply call request in a step S60. The processed red toner supply call request is transmitted to the NRS 305 in the step S60. Subsequently, in a step S61 it is determined whether or not the red toner supply call has been successfully completed based upon the report from the NRS 305. If a call OK is received from the NRS 305 before the retrial counter reaches “0,” it is determined that the red toner supply call to the management apparatus 102 was successful and the preferred process proceeds to a step S62 for performing the following steps. In the step S62, the red toner supply call complete flag in the NV-RAM 202 is set to “1,” and in a step S63, the red toner post call paper counter value is set to “0.” Subsequently, in a step S64, the retrial counter is reset to “0.” Lastly, the red supply call in-progress flag in the NV-RAM 202 is reset to “0” in a step S65 before the preferred process terminates itself.

On the other hand, a call NG is received from the NRS 305 in the S61, it is determined that the toner supply call to the management apparatus 102 was unsuccessful and the preferred process proceeds to a step S66. After the retrial counter in the NV-RAM 202 has been decremented by one in the step S66, the retrial counter value is checked in a step S67. If the retrial counter value is not zero, the identical red toner supply call has not repeated three times. In this case, the preferred process returns to the step S60, where the identical initial time red toner supply call request is reported to the NRS 305. The identical initial time red toner supply call request includes the device number of the image forming apparatus 100 and the identical initial time call ID that is stored in the NV-RAM 202. The above described steps S60, S61 and S66 are repeated until the retrial counter reaches “0.”

FIG. 25 is a flow chart illustrating steps involved in a part of the preferred process of handling the above red toner supply call from an image forming apparatus to a management apparatus in the remote management system according to the current invention. When the retrial counter reaches “0” as determined in the step S67 in FIG. 23, the preferred process performs the following steps S68 through S71. In a step S68, the red tone mail transmission complete flag value in the NV-RAM 202 is checked. If it is confirmed that the red toner mail transmission complete flag value is set to “1,” the preferred process proceeds to a step S71, where the 24-hour time is activated. On the other hand, it is confirmed that the red toner mail transmission complete flag value is reset to “0,” an e-mail transmission request for indicating the failed red toner supply call to the management apparatus 102 is transmitted to the DCS 316 in a step S69. The device number information of the image forming apparatus 100 and the identical initial time call ID are added to the e-mail transmission request. After the e-mail transmission request is reported to the DCS 316, the black toner mail transmission complete flag in the NV-RAM 202 is set to “1” in a step S70. Subsequently, the 24-hour time is activated in the step S71, and the preferred process returns to the step S59 of FIG. 23 after twenty-four hours have elapsed.

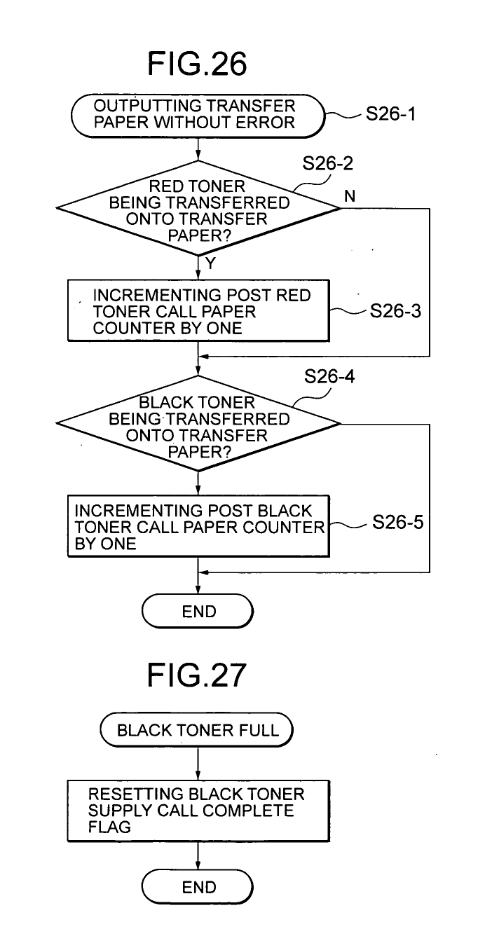

FIG. 26 is a flow chart illustrating steps involved in a preferred process of normal outputting of transfer paper according to the current invention. The SCS 306 initiates a routine upon detecting a normal output of transfer paper subsequent to an image being formed on the transfer paper. In a step S26-1, it is determined whether or not red toner is used to transfer an image onto transfer paper or image-carrying medium. If it is confirmed that the red toner is used in the step S26-2, the preferred process proceeds to a step S26-3, where a red toner post call paper counter is incremented by one. On the other hand, if it is confirmed that the red toner is not used in the step S26-2, the preferred process proceeds to a step S26-4. It is further determined in the step S26-4 whether or not black toner is used to transfer an image onto transfer paper or image-carrying medium. If it is confirmed that the black toner is used in the step S26-4, the preferred process proceeds to a step S26-5, where a black toner post call paper counter is incremented by one and the preferred process terminates. On the other hand, if it is confirmed that the black toner is not used in the step S26-4, the preferred process proceeds to terminate.

Now referring to FIG. 27, a flow chart illustrates steps involved in a preferred process of resetting the black toner supply call complete flag according to the current invention. A toner full event occurs after a black toner bottle is replaced and the corresponding detection unit detects the corresponding event. In response to the black toner full event such as seen in the sequence 20-3 of FIG. 20, the SCS 306 of the control board 200 in the image forming apparatus 100 resets the black toner supply call complete flag to “0” in the NV-RAM 202.

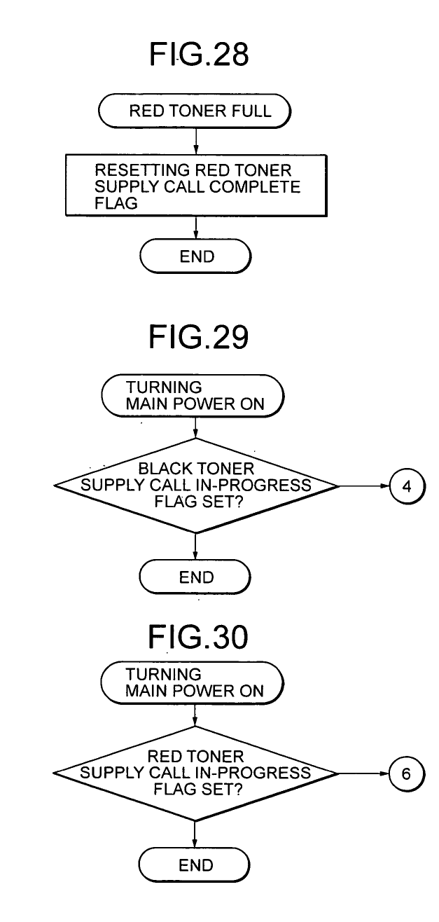

Now referring to FIG. 28, a flow chart illustrates steps involved in a preferred process of resetting the red toner supply call complete flag according to the current invention. A toner full event occurs after a red toner bottle is replaced and the corresponding detection unit detects the corresponding event. In response to the red toner full event such as seen in the sequence 20-5 of FIG. 20, the SCS 306 of the control board 200 in the image forming apparatus 100 resets the red toner supply call complete flag to “0” in the NV-RAM 202.

Now referring to FIG. 29, a flow chart illustrates steps involved in a preferred process of setting the black toner supply call in-progress flag according to the current invention. Upon activating the main power source of the image forming apparatus 100, the SCS 306 of the control board 200 in the image forming apparatus 100 checks the black toner supply call in-progress flag in the NV-RAM 202. When it is confirmed that the black toner supply call in-progress flag is set to “1,” the preferred process proceeds to the step S39 of FIG. 22 to perform the subsequent steps.

Now referring to FIG. 30, a flow chart illustrates steps involved in a preferred process of setting the red toner supply call in-progress flag according to the current invention. Upon activating the main power source of the image forming apparatus 100, the SCS 306 of the control board 200 in the image forming apparatus 100 checks the red toner supply call in-progress flag in the NV-RAM 202. When it is confirmed that the red toner supply call in-progress flag is set to “1,” the preferred process proceeds to the step S59 of FIG. 23 to perform the subsequent steps.

With respect to the second preferred embodiment, the following ten advantages are gained. (1) When the image forming apparatus 100 or 110 detects its own toner near end condition, it determines a toner near end type, and the toner supply call information for notifying a toner bottle order with the toner near end type is sent to the management apparatus 102. By setting the corresponding supply call in-progress flag to “1,” even if the transmission of the toner supply call information is interrupted by turning off the main power source, the in-progress transmission of the corresponding toner supply call information is resumed by referring to the status of the corresponding supply call in-progress flag after the main power is again turned on.

(2) When the image forming apparatus 100 transmits either type of the toner supply calls to the management apparatus 102, a call ID is generated to identify the transmission. By adding the call ID to the toner supply call information, since the duplicate transmission from the image forming apparatus 100 for the identical toner supply call information is recognized at the management apparatus 102, the duplicate ordering of a black or red toner bottle is prevented.

(3) When the image forming apparatus 100 receives from the management apparatus 102 a transmission result indicative of a normal reception of the black or red toner supply call, it is determined that the transmission of the toner supply call information is successful. By resetting the corresponding supply call in-progress flag to “0,” it is subsequently confirmed that the transmission of either the black or red toner supply call information is completed by referring to the status of the SC call complete flag.

(4) When the image forming apparatus 100 fails to receive from the management apparatus 102 a transmission result indicative of a normal reception of either the black or red toner supply call, it is determined that the transmission of the toner supply call information is unsuccessful. In the event of the failed transmission, if the number of transmission of the identical toner supply call information has not reached a predetermined number, the toner supply call information is transmitted to the management apparatus 102. If the number of transmission of the identical toner supply call information has reached a predetermined number, the retrial of the toner supply call is terminated. By the above transmission controls, even if a communication trouble occurs during the toner supply call transmission, the transmission of either the black or red toner supply call information is completed.

(5) Since the image forming apparatus 100 repeatedly adds the identical initial time call ID to the black or red toner supply call information during the transmission retrials, the image forming apparatus 100 does not have to generate a different call ID for transmitting the identical toner supply call information. As a result, the processing efficiency increases.

(6) After the image forming apparatus 100 stops the re-transmission of the toner supply call information, by reporting to a supply management terminal via e-mail that either the black or red toner supply call to the management apparatus has failed, the supply management personnel of the supply management terminal refers to the reported content so that he or she can communicate with a center operator about the black or red toner bottle order in the corresponding toner supply cal information. In lieu of reporting to the supply management terminal, the same information is displayed on the operation panel 205 or printed on paper. That is, the content of the black or red toner supply call information is assuredly communicated to the center operator.

(7) After the failed toner supply call transmission to the management apparatus 102 is reported via e-mail, the image forming apparatus 100 sets the corresponding mail flag transmission complete flag indicative of the complete e-mail transmission to “1” to prohibit the same report so that the duplicate report is avoided. The above mechanism improves the processing efficiency.

(8) After the mail flag transmission complete flag has been set to “1,” if a toner near end situation is detected, the corresponding mail flag transmission complete flag is now reset to “0” to release the prohibition of the e-mail transmission. As a result of the corresponding reset flag, the e-mail transmission for the failed toner supply call to the management apparatus 102 is again enabled. By the above mechanism, the content of the black or red toner supply call is assuredly reported to the center operator.

(9) After the image forming apparatus 100 activates the 24-hour timer and 24 hours have elapsed by the measurement of the 24-hour timer, by performing the retransmission as described above, the content of the black or red toner supply call is furthermore assuredly reported to the center operator. Alternatively, in lieu of the 24-hour timer, any timer that measures a predetermined amount of time is used in the above system.

(10) When a main power source is turned ON, the image forming apparatus 100 evaluates the corresponding black or red toner supply call in-progress flag. If the image forming apparatus 100 confirms that the corresponding toner supply call in-progress flag has been set to “1,” it determines that the black or red toner supply call to the management apparatus 102 has failed and performs the above described retransmission. Even if its own main power supply source is turned to interrupt the transmission of the black or red toner supply call to the management apparatus 102, the image forming apparatus 100 automatically resumes the interrupted transmission of the corresponding toner supply call information when the power supply source is turned on. As a result, the content of the black or red toner supply call is expediently and assuredly reported to the center operator. Furthermore, upon the power on, if the image forming apparatus 100 confirms that the black or red toner supply call in-progress flag has been set to “1,” it determines that the corresponding toner supply call to the management apparatus 102 has failed and performs the above described retransmission. The failed transmission is reported by displaying on a display unit on the operation panel 205 or is printing on paper. If the above reporting is done, the corresponding in-progress toner supply call is resumed based upon the toner type, for example, by the operation on the operation panel 205.

In the second preferred embodiment, the image forming apparatus is equipped with a black toner bottle and a red toner bottle. In detecting a toner near event for either of the bottles, a corresponding toner supply call information indicative of the detected toner near end is transmitted to the management apparatus 102 to order a corresponding toner bottle. Similarly, the image forming apparatus is equipped with a cyan (C) toner bottle, a magenta (M) toner bottle, a yellow toner bottle and a black (K) toner bottle. In detecting a toner near event for any of the bottles, a corresponding toner supply call information indicative of the detected toner near end is transmitted to the management apparatus 102 for ordering a corresponding toner bottle. For example, other the toner near end event, other preventive alert situations include a staple near end and a stamp ink near end. The staple near end occurs when a number of remaining staple needles falls below a predetermined number. The stamp ink near end occurs when a remaining amount of stamp ink falls below a predetermined amount. In detecting the staple near end event, the corresponding staple order information is transmitted to the management apparatus 102. Similarly, in detecting the stamp ink near end event, the corresponding stamp ink order information is transmitted to the management apparatus 102. If there is a plurality of staple types, in detecting a staple near end, the information of a corresponding type of staples is also sent to the management apparatus 102. Similarly, if there is a plurality of stamp ink types, in detecting a stamp ink near end, the information of a corresponding type of stamp ink is also sent to the management apparatus 102.

In the above described preferred embodiments, the communication device has been described with respect to the exemplary implementations in the image forming apparatus 110 with a communication function or an intermediate function or the image forming apparatus 110 in connection with the intermediate device 101 having a communication function. The current invention is not limited to the above exemplary implementations, but is applicable to various electronic devices having a communication function or being connected to an intermediate device having a communication function. The electronic devices include network-based appliances, automatic vending machines, medical devices, power supplies, air conditioning systems, metering systems for utility such as gas, water and electricity and network-connectable computers. If these devices are used as the managed devices, the above described remote system according to the current invention are operated in the same manner. Furthermore, in the communication devices in the remote management system, the components and the connection format of the communication device, the remote management intermediate device and the management device are not limited to the above illustrated components and connection formats of the preferred embodiments.

The preferred embodiments of the computer programs according to the current invention implement the various functions by the computer controlling the communication device for communicating with an external device in the above described image forming apparatus. The various functions include a situation information transmission generation means, a situation information transmission means, a situation information transmission interruption status setting means, a transmission result determination means, a situation information transmission interruption status removing means, a transmission failure notification means, a notification complete status setting means, a notification prohibition removing means, a time measuring means and a situation type determination means. By executing the program by the computer, the above described effects are obtained. The program is stored in a storage unit such as a hard disk or read only memory (ROM) in the computer. Alternatively, the program is stored in non-volatile memory media such as CD-ROM, floppy disks, SRAM, EEPROM and memory cards. The program stored in the memory is installed in the computer and is executed. Alternatively, the program is read from the memory and is executed. The execution implements the above procedures. Furthermore, the program is alternatively downloaded from an external device with a storage medium storing the program or from an external device with a recording means storing the program.

What is claimed is:

1. A method of communicating, comprising the steps of:
detecting one of a predetermined set of events at a first device;
setting a communication in-progress flag to a in-progress status prior to reporting to a second device;
transmitting a report on the detected event from the first device to the second device; and
determining whether or not said transmitting step has been interrupted based upon the communication in-progress flag.

2. The method of communicating according to claim 1 further comprising additional steps of:
receiving a transmission result on reception of the report at the second device;
determining whether or not the transmission is successful based upon the transmission result to generate a successful transmission result in case that the report has been successfully received at the second device; and
resetting the communication in-progress flag to a not-in-progress status in case of the successful transmission result.

3. The method of communicating according to claim 1 further comprising additional steps of:
receiving a transmission result on reception of the report at the second device;
determining whether or not the transmission is failed based upon the transmission result to generate a failed transmission result in case that the report has not been successfully received at the second device; and
repeating said transmitting step of transmitting the report in case of the failed transmission result until a predetermined number of retrials has reached.

4. The method of communicating according to claim 3 wherein the failed transmission result is sent to the first device after the repeated retrials have ended.

5. The method of communicating according to claim 4 wherein an e-mail transmission complete flag is set to true after the failed transmission result is sent, the e-mail transmission complete flag being indicative of prohibiting further transmission of the failed transmission result to the first device.

6. The method of communicating according to claim 5 wherein after the e-mail transmission complete flag has been set to true, in case of detecting one of the predetermined set of the events, the e-mail transmission complete flag being set to untrue to indicate that further transmission of the failed transmission result to the first device is allowed again.

7. The method of communicating according to claim 5 further comprising the additional steps of:
starting a timer to measure a predetermined amount of time after the predetermined number of the retrials has reached; and
repeating said transmitting step of transmitting the report to the second device in case of the failed transmission result after the predetermined amount of time has elapsed.

8. The method of communicating according to claim 5 further comprising the additional steps of:
checking the communication in-progress flag upon activating a main power supply at the first device;
determining that the report has not been successfully received at the second device if the communication in-progress flag has been set to the in-progress status; and
repeating said transmitting step of transmitting the report to the second device.

9. The method of communicating according to claim 1 further comprising additional steps of:
identifying a type of the detected event at the first device;
adding the identified type to the report to the second device; and
setting the in-progress status in a corresponding one of the communication in-progress flags indicative of the identified type.

10. The method of communicating according to claim 9 further comprising additional steps of:
receiving a transmission result on reception of the report at the second device;
determining whether or not the transmission is successful based upon the transmission result to generate a successful transmission result in case that the report has been successfully received at the second device; and
resetting the not in-progress status the corresponding one of the communication in-progress flag indicative of the identified type.

11. The method of communicating according to claim 9 further comprising additional steps of:
receiving a transmission result on reception of the report at the second device;
determining whether or not the transmission is failed based upon the transmission result to generate a failed transmission result in case that the report has not been successfully received at the second device; and
repeating said transmitting step of transmitting the report in case of the failed transmission result until a predetermined number of retrials has reached.

12. The method of communicating according to claim 11 wherein the failed transmission result to the second device is sent after the repeated retrials have ended.

13. The method of communicating according to claim 12 wherein an e-mail transmission complete flag is set to true after the failed transmission result is sent, the e-mail transmission complete flag being indicative of prohibiting further transmission of the failed transmission result to the second device.

14. The method of communicating according to claim 13 wherein after the e-mail transmission complete flag has been set to true, in case of detecting one of the predetermined set of the events, the e-mail transmission complete flag being set to untrue to indicate that further transmission of the failed transmission result to the second device is allowed again.

15. The method of communicating according to claim 1 wherein the report is converted into a structured language before said transmitting step.

16. The method of communicating according to claim 1 wherein said transmitting step is interrupted by a main power supply deactivation of the first device.

17. The method of communicating according to claim 1 wherein the first device is an image forming device while the second device is a management device.

18. A communication device, comprising:
an event detecting unit for detecting one of a predetermined set of events at a first device;
a communication in-progress flag setting unit for setting a communication in-progress flag to a in-progress status prior to transmitting to a second device, the communication in-progress flag indicative of the transmission being in an in-progress status in case of interruption during the transmission; and
an event information transmission unit connected to said event detection unit for transmitting a report on the detected event from the first device to the second device.

19. The communication device according to claim 18 further comprising:
a transmission result determination unit for receiving a transmission result on reception of the report at the second device and determining whether or not a transmission is successful based upon the transmission result to generate a successful transmission result in case that the report has been successfully received at the second device; and
a communication in-progress flag resetting unit connected to said transmission result determination unit for resetting the communication in-progress flag to a not-in-progress status in case of the successful transmission result.

20. The communication device according to claim 19 wherein said transmission result determination unit receives the transmission result on reception of the report at the second device and determines whether or not the transmission is failed based upon the transmission result to generate a failed transmission result in case that the report has not been successfully received at the second device, said event information transmission unit repeating to transmit the report in case of the failed transmission result until a predetermined number of retrials has reached.

21. The communication device according to claim 20 further comprising a transmission failure reporting unit connected to said transmission result determination unit for transmitting the failed transmission result to the first device after the repeated retrials have ended.

22. The communication device according to claim 21 further comprising an e-mail transmission complete flag setting unit connected to said transmission failure reporting unit for setting an e-mail transmission complete flag to true after the failed transmission result is sent, the e-mail transmission complete flag being indicative of prohibiting further transmission of the failed transmission result to the first device.

23. The communication device according to claim 22 wherein after the e-mail transmission complete flag has been set to true, in case that said event detecting unit detects one of the predetermined set of the events, claim 23 further comprising an e-mail transmission complete flag resetting unit for resetting the e-mail transmission complete flag to untrue to indicate that further transmission of the failed transmission result to the first device is allowed again.

24. The communication device according to claim 22 further comprising a timer connected to said transmission failure reporting unit for starting to measure a predetermined amount of time after the predetermined number of the retrials has reached, said event information transmission unit repeating to transmit the report to the second device in case of the failed transmission result after the predetermined amount of time has elapsed.

25. The communication device according to claim 22 wherein said transmission result determination unit checking the communication in-progress flag upon activating a main power supply at the first device and determining whether or not the report has not been successfully received at the second device if the communication in-progress flag has been set to the in-progress status, said event information transmission unit repeating to transmit the report to the second device.

26. The communication device according to claim 18 further comprising an event identifying unit connected to said event detecting unit and said event information transmission unit for identifying a type of the detected event at the first device, said event information transmission unit adding the identified type to the report to the second device, said communication in-progress flag setting unit setting the in-progress status in a corresponding one of the communication in-progress flag indicative of the identified type.

27. The communication device according to claim 26 further comprising a transmission result determination unit receiving a transmission result on reception of the report at the second device and determining whether or not the transmission is successful based upon the transmission result to generate a successful transmission result in case that the report has been successfully received at the second device, claim 26 further comprising a communication in-progress flag resetting unit resetting the not in-progress status in the corresponding one of the communication in-progress flags indicative of the identified type.

28. The communication device according to claim 27 wherein said transmission result determination unit receives the transmission result on reception of the report at the second device and determines whether or not the transmission is failed based upon the transmission result to generate a failed transmission result in case that the report has not been successfully received at the second device, said event information transmission unit repeating to transmit the report in case of the failed transmission result until a predetermined number of retrials has reached.

29. The communication device according to claim 28 further comprising a transmission failure reporting unit connected to said transmission result determination unit for transmitting the failed transmission result to the second device after the repeated retrials have ended.

30. The communication device according to claim 29 further comprising an e-mail transmission complete flag setting unit connected to said transmission failure reporting unit for setting an e-mail transmission complete flag to true after the failed transmission result is sent, the e-mail transmission complete flag being indicative of prohibiting further transmission of the failed transmission result to the second device.

31. The communication device according to claim 30 wherein after the e-mail transmission complete flag has been set to true, in case that said detecting unit detects one of the predetermined set of the events, claim 30 further comprising an e-mail transmission complete flag resetting unit for resetting the e-mail transmission complete flag to untrue to indicate that further transmission of the failed transmission result to the second device is allowed again.

32. The communication device according to claim 18 wherein the report is converted into a structured language before said transmitting step.

33. The communication device according to claim 18 wherein said event information transmission unit is interrupted by a main power supply deactivation of the first device.

34. The communication device according to claim 18 wherein the first device is an image forming device while the second device is a management device.

35. A remote management system for remotely managing a plurality of communication devices via network, comprising:
each of the communication devices further comprising:
a managed communication unit for communicating with the management device;
an event detecting unit for detecting one of a predetermined set of events at a first device;
an event information transmission unit connected to said event detection unit and said managed communication unit for transmitting a report on the detected event to the management device via said managed communication unit, said event information transmission unit adding its own identity information to the report; and
a communication in-progress flag setting unit connected to said event information transmission unit for setting a communication in-progress flag to a in-progress status before said event information transmission unit transmits the report, the communication-in-progress flag indicative of the transmission being in an in-progress status in case of interruption during the transmission;
the management device further comprising:
a management communication unit for communicating with the communication devices; and
a transmission result transmission unit for receiving via said management communication unit the report from one of the communication devices, in case that the reception is successful said transmission result transmission unit transmitting via said management communication unit a transmission result to one of the communication devices that has sent the report based upon the own identity in the report.

36. The remote management system according to claim 35 wherein each of the communication devices further comprising:
a transmission result determination unit for receiving a transmission result on reception of the report at the management device and determining whether or not a transmission is successful based upon the transmission result to generate a successful transmission result in case that the report has been successfully received at the management device; and
a communication in-progress flag resetting unit connected to said transmission result determination unit for resetting the communication in-progress flag to a not-in-progress status in case of the successful transmission result.

37. The remote management system according to claim 36 wherein said transmission result determination unit receives the transmission result on reception of the report at the management device and determines whether or not the transmission is failed based upon the transmission result to generate a failed transmission result in case that the report has not been successfully received at the management device, said event information transmission unit repeating to transmit the report in case of the failed transmission result until a predetermined number of retrials has reached.

38. The remote management system according to claim 37 wherein each of the communication devices further comprises a transmission failure reporting unit connected to said transmission result determination unit for transmitting the failed transmission result to the management device after the repeated retrials have ended.

39. The remote management system according to claim 38 wherein each of the communication devices further comprises an e-mail transmission complete flag setting unit connected to said transmission failure reporting unit for setting an e-mail transmission complete flag to true after the failed transmission result is sent, the e-mail transmission complete flag being indicative of prohibiting further transmission of the failed transmission result to the first device.

40. The remote management system according to claim 39 wherein after the e-mail transmission complete flag has been set to true, in case that said event detecting unit detects one of the predetermined set of the events, claim 40 further comprising an e-mail transmission complete flag resetting unit for resetting the e-mail transmission complete flag to untrue to indicate that further transmission of the failed transmission result to the communication device is allowed again.

41. The remote management system according to claim 37 wherein each of the communication devices further comprises a timer connected to said transmission failure reporting unit for starting to measure a predetermined amount of time after the predetermined number of the retrials has reached, said event information transmission unit repeating to transmit the report to the management device in case of the failed transmission result after the predetermined amount of time has elapsed.

42. The remote management system according to claim 41 wherein said transmission result determination unit checking the communication in-progress flag upon activating a main power supply at the communication device and determining whether or not the report has not been successfully received at the second device if the communication in-progress flag has been set to the in-progress status, said event information transmission unit repeating to transmit the report to the management device.

43. The remote management system according to claim 35 wherein each of the communication devices further comprises an event identifying unit connected to said event detecting unit and said event information transmission unit for identifying a type of the detected event at the communication device, said event information transmission unit adding the identified type to the report to the management device, said communication in-progress flag setting unit setting the in-progress status in a corresponding one of the communication in-progress flags indicative of the identified type.

44. The remote management system according to claim 43 wherein each of the communication devices further comprises a transmission result determination unit receiving a transmission result on reception of the report at the management device and determining whether or not the transmission is successful based upon the transmission result to generate a successful transmission result in case that the report has been successfully received at the management device, each of the communication devices also further comprising a communication in-progress flag resetting unit for resetting the not in-progress status in the corresponding one of the communication in-progress flags indicative of the identified type.

45. The remote management system according to claim 44 wherein said transmission result determination unit receives the transmission result on reception of the report at the management device and determines whether or not the transmission is failed based upon the transmission result to generate a failed transmission result in case that the report has not been successfully received at the management device, said event information transmission unit repeating to transmit the report in case of the failed transmission result until a predetermined number of retrials has reached.

46. The remote management system according to claim 45 wherein each of the communication devices further comprises a transmission failure reporting unit connected to said transmission result determination unit for transmitting the failed transmission result to the management device after the repeated retrials have ended.

47. The remote management system according to claim 46 wherein each of the communication devices further comprises an e-mail transmission complete flag setting unit connected to said transmission failure reporting unit for setting an e-mail transmission complete flag to true after the failed transmission result is sent, the e-mail transmission complete flag being indicative of prohibiting further transmission of the failed transmission result to the management device.

48. The remote management system according to claim 47 wherein after the e-mail transmission complete flag has been set to true, in case that said detecting unit detects one of the predetermined set of the events, claim 47 further comprising an e-mail transmission complete flag resetting unit for resetting the e-mail transmission complete flag to untrue to indicate that further transmission of the failed transmission result to the management device is allowed again.

49. A medium containing computer executable instructions for communicating, the instructions comprising the tasks of:
detecting one of a predetermined set of events at a first device;
setting a communication in-progress flag to a in-progress status prior to reporting to a second device;
transmitting a report on the detected event from the first device to the second device; and
determining whether or not said transmitting step has been interrupted based upon the communication in-progress flag.

50. The medium containing computer executable instructions according to claim 49 further comprising additional tasks of:
receiving a transmission result on reception of the report at the second device;
determining whether or not the transmission is successful based upon the transmission result to generate a successful transmission result in case that the report has been successfully received at the second device; and
resetting the communication in-progress flag to a not-in-progress status in case of the successful transmission result.

51. The medium containing computer executable instructions according to claim 49 further comprising additional tasks of:
receiving a transmission result on reception of the report at the second device;
determining whether or not the transmission is failed based upon the transmission result to generate a failed transmission result in case that the report has not been successfully received at the second device; and
repeating said transmitting step of transmitting the report in case of the failed transmission result until a predetermined number of retrials has reached.

52. The medium containing computer executable instructions according to claim 51 wherein the failed transmission result is sent to the first device after the repeated retrials have ended.

53. The medium containing computer executable instructions according to claim 52 wherein an e-mail transmission complete flag is set to true after the failed transmission result is sent, the e-mail transmission complete flag being indicative of prohibiting further transmission of the failed transmission result to the first device.

54. The medium containing computer executable instructions according to claim 53 wherein after the e-mail transmission complete flag has been set to true, in case of detecting one of the predetermined set of the events, the e-mail transmission complete flag being set to untrue to indicate that further transmission of the failed transmission result to the first device is allowed again.

55. The medium containing computer executable instructions according to claim 53 further comprising the additional tasks of:
starting a timer to measure a predetermined amount of time after the predetermined number of the retrials has reached; and
repeating said transmitting step of transmitting the report to the second device in case of the failed transmission result after the predetermined amount of time has elapsed.

56. The medium containing computer executable instructions according to claim 53 further comprising the additional tasks of:
checking the communication in-progress flag upon activating a main power supply at the first device;
determining that the report has not been successfully received at the second device if the communication in-progress flag has been set to the in-progress status; and
repeating said transmitting step of transmitting the report to the second device.

57. The medium containing computer executable instructions according to claim 49 further comprising additional tasks of:
identifying a type of the detected event at the first device;
adding the identified type to the report to the second device; and
setting the in-progress status in a corresponding one of the communication in-progress flags indicative of the identified type.

58. The medium containing computer executable instructions according to claim 57 further comprising additional tasks of:
receiving a transmission result on reception of the report at the second device;
determining whether or not the transmission is successful based upon the transmission result to generate a successful transmission result in case that the report has been successfully received at the second device; and
resetting the not in-progress status the corresponding one of the communication in-progress flag indicative of the identified type.

59. The medium containing computer executable instructions according to claim 57 further comprising additional tasks of:
receiving a transmission result on reception of the report at the second device;
determining whether or not the transmission is failed based upon the transmission result to generate a failed transmission result in case that the report has not been successfully received at the second device; and
repeating said transmitting step of transmitting the report in case of the failed transmission result until a predetermined number of retrials has reached.

60. The medium containing computer executable instructions according to claim 59 wherein the failed transmission result to the second device is sent after the repeated retrials have ended.

61. The medium containing computer executable instructions according to claim 60 wherein an e-mail transmission complete flag is set to true after the failed transmission result is sent, the e-mail transmission complete flag being indicative of prohibiting further transmission of the failed transmission result to the first device.

62. The medium containing computer executable instructions according to claim 61 wherein after the e-mail transmission complete flag has been set to true, in case of detecting one of the predetermined set of the events, the e-mail transmission complete flag being set to untrue to indicate that further transmission of the failed transmission result to the second device is allowed again.

63. The medium containing computer executable instructions according to claim 49 wherein the report is converted into a structured language before said transmitting step.

64. The medium containing computer executable instructions according to claim 49 wherein said transmitting step is interrupted by a main power supply deactivation of the first device.

65. The medium containing computer executable instructions according to claim 49 wherein the first device is an image forming device while the second device is a management device.
